(19) United States
(12) Patent Application Publication
(10) Pub. No.: US 2004/0057786 A1
(43) Pub. Date: Mar. 25, 2004

(54) Coupling device, in particular for at least two pieces adjustable relative to each other

(76) Inventor: Roland Heiml, Vocklamarkt (AU)

Correspondence Address: WILLIAM COLLARD, COLLARD & ROE, P.C., 1077 NORTHERN BOULEVARD, ROSLYN, NY, 11576, US

(21) Appl. No.: 10/399,814

(22) PCT Filed: Oct. 23, 2001
(86) PCT No.: PCT/AT01/00342

(30) Foreign Application Priority Data
Oct. 25, 2000 (AT) 1831/2000
Feb. 21, 2001 (AT) 270-2001

(51) Int. Cl. F16B 2/00

(52) U.S. Cl. 403/373

(57) ABSTRACT

The invention relates to a coupling mechanism (88), in particular for at least two relatively adjustable parts, each of which is provided with at least one coupling element (65, 72), and the coupling elements (65, 72) are provided with coupling parts standing slightly proud of a bearing surface (53, 54) of the parts receiving them and can be brought into engagement with one another, the coupling parts being of an elastically flexible, reversible design and being designed so as to locate with one another in certain regions in each of their relative positions in order to releasably fix the positioned parts. The parts (89; 90) can be pressurised in order to transmit force in the direction parallel with the bearing surface (53; 54) and are disposed so as to be relatively displaceable by means of an adjusting device (50; 51) for engaging or disengaging the locatable coupling elements (65, 72) at least at an angle relative to the bearing surface (53; 54), in particular perpendicular to the bearing surface (53; 54).

The invention relates to a coupling mechanism, in particular for at least two parts that are adjustable relative to one another, of the type described in the generic parts of claims 1 and 2, and the use of the coupling mechanism as an energy-absorbing deformation system, as described in claim 51.

A number of adjusting mechanisms are already known, which are fitted with a fixing mechanism incorporating a coupling mechanism between two parts that are adjustable relative to one another, where each of the parts has a respective coupling element and the coupling elements of the parts are releasably fixed in a located locked position obtained by a form-fitting arrangement which fixes their relative position against the action of elastically deformable return elements. The coupling elements forming a coupling mechanism, disposed opposite one another so that they can be brought into engagement, have several rigid coupling parts which are spaced at a distance apart from one another or immediately one after the other. The disadvantage of fixing mechanisms or coupling mechanisms of this type primarily resides in the fact that because the coupling parts are disposed so as to locate with one another, a relative position between two relatively adjustable parts can be fixed but only at predetermined distances.

The underlying objective of the invention is to propose an adjusting mechanism co-operating with a fixing system having a coupling mechanism, which enables several parts that are adjustable relative to one another to be steplessly fixed in a set relative position.

The objective of the invention is achieved as a result of the characterising features defined in claim 1. The surprising advantages obtained as a result of the features defined in the characterising part of claim 1 are that high forces can be applied to the relatively adjustable parts by means of a coupling mechanism in a direction parallel with the bearing surface, without causing any shift in the relative position of the parts. Another advantage of the compact coupling elements also primarily resides in the fact that, firstly, only a small amount of mounting space is needed because of the compact construction and, secondly, only short adjustment paths are needed to engage or disengage the locatable coupling elements. Furthermore, the mutually locatable elements can be coupled in any relative position, thereby enabling a relative position of several parts to be fixed in a stepless arrangement.

The objective is also achieved by the invention as a result of the characterising features set out in claim 2. The surprising advantages of this approach are that, because the coupling parts of the coupling elements which can be moved into engagement or located with one another are of a resiliently flexible and reversible design, even if several parts come into contact with one another they can be pushed sideways out of the way and, as the adjusting mechanism is further adjusted, other part regions of the coupling elements and their coupling parts can locate with one another in a form-fitting arrangement, which means that a major part of the located coupling parts can be used as a means of transmitting forces acting in the direction parallel with or at an incline to the bearing surface. This enables a fine adjustment or fixture in several spatial directions in order to fix this set relative position. It also enables a stepless engagement of the locating coupling elements.

Other embodiments defined in claims 3 and 4 are also of advantage because the pressure applied by the coupling elements during the locating process prevents the located, fixed locking position from inadvertently being released.

With the embodiment defined in claim 5, the coupling mechanism can be used as an energy-absorbing safety mechanism, for example, in which case, provided they are not too high, impact forces can be absorbed by the coupling mechanism without damaging it.

Also of advantage are the embodiments defined in claims 6 to 10, whereby, when the coupling elements are located in order to fix a relative position between at least two relatively adjustable parts, in particular in a motor vehicle, a form-fitting arrangement is obtained in certain regions whilst a and form-fitting and/or frictional-locking arrangement is obtained in other regions.

As a result of the embodiments defined in claims 11 and 12, if at least two of the profile crests of the two relatively adjustable coupling elements come into contact with one another, they are pushed together, as a result of which the deflected material is pushed into the profile troughs adjacent to the profile crests, and, as a result of the pressure applied, the parts which are located in a fixing and locking position produce a friction lock for the coupling elements and parts in the region of the abutting profile crests, and, because of the deformation which occurs between the abutting profile crests, additionally generates a form-fit connection, so that the releasably fixable parts are easily able to transmit high forces into the bearing surface in a parallel or inclined direction.

Claims 13 and 14 enable adjustments to be made in order to accommodate various requirements. The embodiments defined in claims 15 and 16 enable the fixing of the relatively adjustable parts to be influenced directly at the profiled surface constituting the locating surface, so that the best possible adjustments can be made in order to meet certain requirements, such as force transmission.

The embodiments defined in claims 17 to 21 have proved to be of advantage because they increase the amount of force or torque which can be transmitted. Another advantage is the fact that the entire profiled surface can be used as a means of transmitting force.

Other advantages are to be had from the embodiments defined in claims 22 to 24, because a set relative position between several parts can be reliably fixed due to the resiliently flexible and reversible design of the coupling elements, even if the distances separating them are different and/or the number of coupling parts differs, and because of the pre-settable contact force of the adjusting mechanism.

The embodiments defined in claims 25 and 26 produce a secure fixture for the parts in every set relative position. Accordingly, the parts can be pushed in two spatial directions and/or turned towards one another.

Also of advantage is an embodiment defined in claim 27, because one of the surfaces of the support body is designed to lock or fix the coupling elements on one part and the other surface is designed to serve as a locating surface for releasably fixing a relative position. Furthermore, as a result of the distribution of the coupling parts on the surface of the support body, a relative position can be adjusted and fixed steplessly.

Advantages are also to be had from an embodiment as defined in claim 28, whereby any undesirable shifting of a relative position between two mutually fixed parts is prevented in a direction parallel with the bearing surface.

The advantage of the embodiment defined in claim 29 is that even wear and tear on the coupling parts caused by friction will not adversely affect fixing of the parts, and in particular will not lead to a reduction in the fixing forces.

As a result of the embodiment defined in claim 30, a part incorporating the coupling element can be made by an in expensive manufacturing process.

As defined in claim 31, forces or, if necessary torques, acting parallel with or at an angle to the seating surface can be eliminated.

The embodiments defined in claims 32 to 34 are also of advantage because different geometric shapes and materials can be used for the slightly flexible coupling elements and coupling parts in order to adapt to different requirements.

Claims 35 to 39 define a structurally simple and compact construction.

As a result of the embodiment defined in claim 40, the components slightly biassed towards one another offer a simple and essentially clearance-free way of adjusting the parts, in particular the steering shaft, relative to the mount, whereby the coupling parts are totally disengaged during the adjustment process, which prevents any friction-induced wear of the coupling elements during the process of adjusting the parts.

The embodiment of the coupling parts described in claim 41 is of advantage because the energy generated in the event of the vehicle colliding is largely absorbed by the coupling parts and projections, causing no undesirable lifting of the coupling parts from one another, which might cause the mutually fixed parts to be released. Consequently, movement is only possible, as an option, in the longitudinal direction of the coupling elements, which likewise leads to an absorption of energy.

Another possible embodiment is that defined in claim 42, whereby the co-operation of an essentially form-fitting and/or friction-locking fixture of the parts relative to one another provides a reliable fixing arrangement.

As defined in claims 43 and 44, an inexpensive fixing means known from the prior art can be used to provide a durable fixture between the coupling elements and the parts.

The embodiments defined in claims 45 and 46 enable any set relative position to be fixed, in particular an angle of inclination, length or height, between relatively adjustable parts, for example between a back part and seat part or a body and another part of a height-adjusting mechanism of a restraining element.

An embodiment of the coupling elements defined in claims 47 and 48 is also of advantage, resulting in a rapid cycle time dependent solely on the pressure applied in order to fix and lock the parts in a predetermined position relative to one another.

Advantageous embodiments are defined in claims 49 and 50, enabling standardised actuators to be used for engaging and disengaging the positioning elements.

Another advantage is that the coupling elements can be designed in an energy-absorbing deforming arrangement in respect of a force or energy acting in the longitudinal direction and/or transversely to the longitudinal direction, as described in claim 51, because the deformation of the coupling elements and coupling parts enables at least some of the kinetic energy to be absorbed.

In order to provide a clearer understanding, the invention will be explained in more detail below with reference to the appended drawings.

Of these:

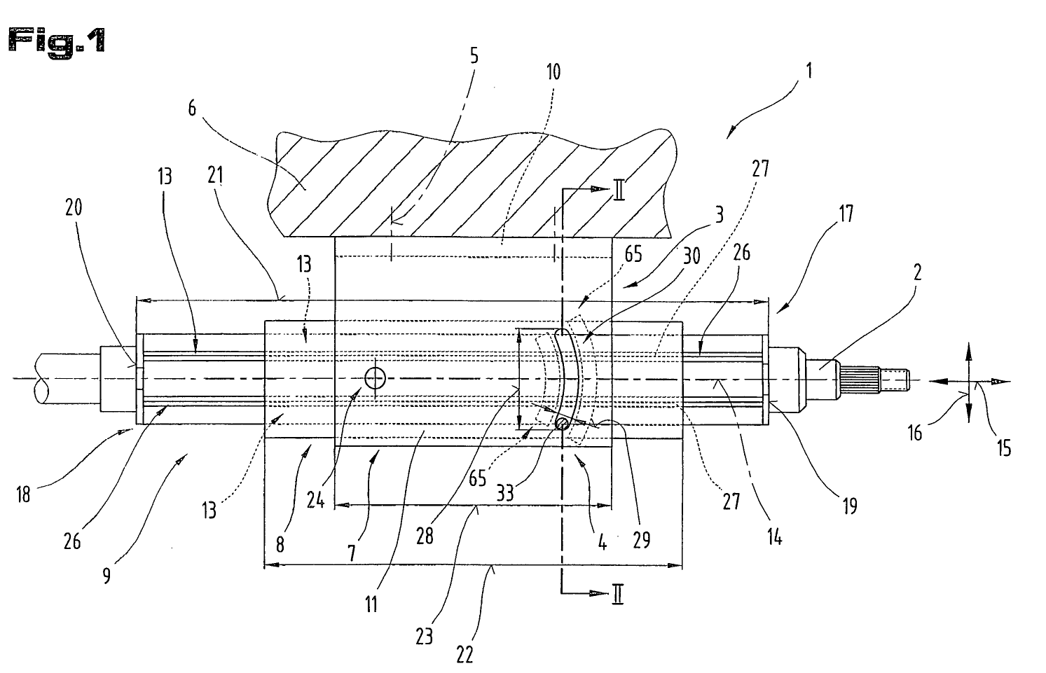

FIG. 1 is a highly simplified, schematic diagram showing a side view of a steering shaft unit;

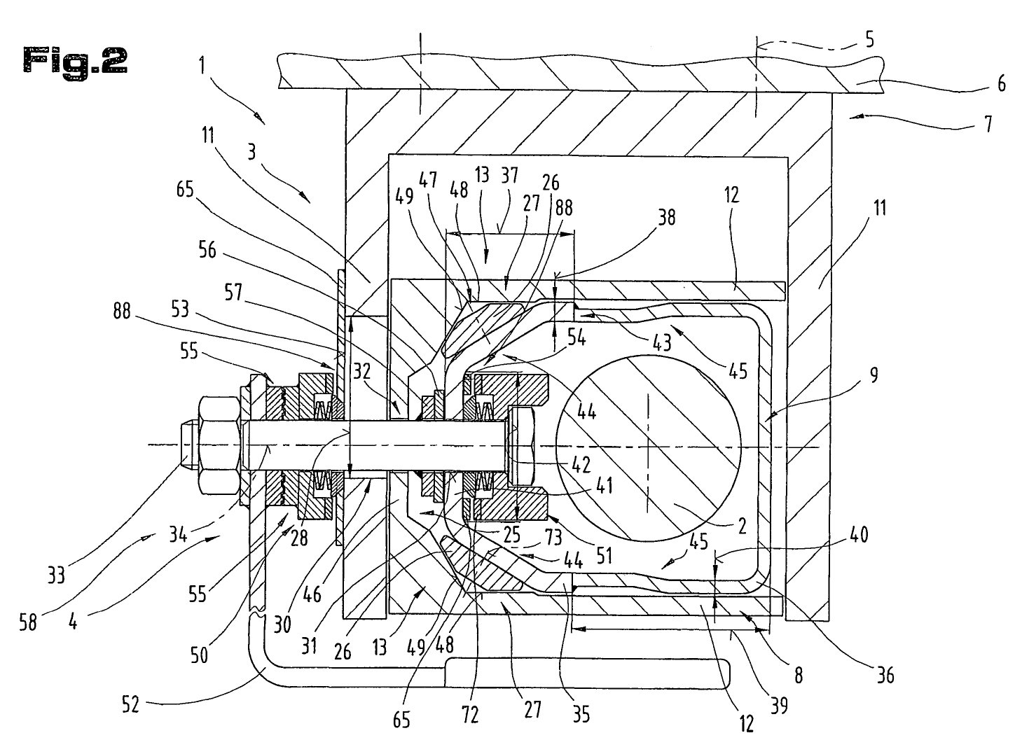

FIG. 2 is a highly simplified, schematic diagram showing a side view in section along line II-II indicated in FIG. 1 of a steering shaft unit with at least one adjusting and fixing mechanism as proposed by the invention in the disengaged open position;

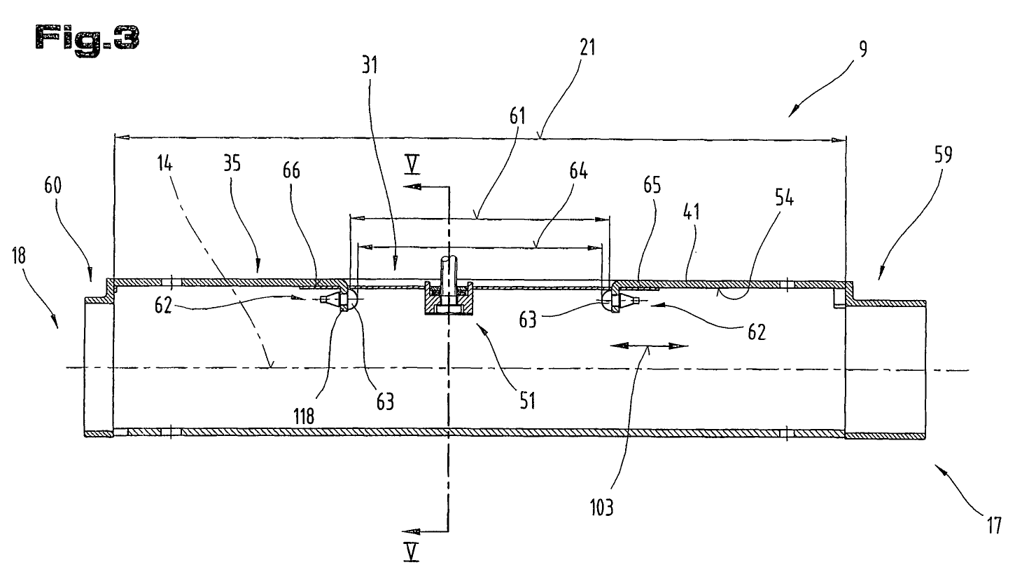

FIG. 3 is a highly simplified, schematic diagram showing a side view of a support element in section;

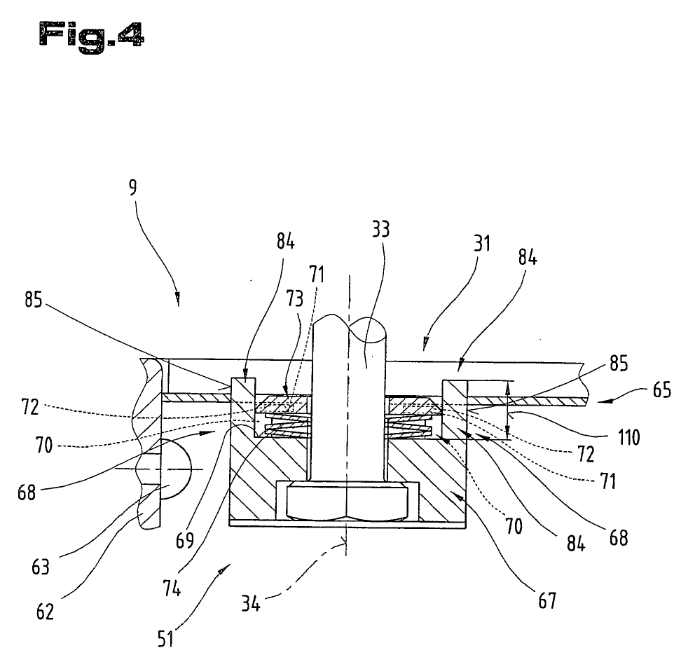

FIG. 4 is a highly simplified, schematic diagram illustrating a part-region of the fixing mechanism proposed by the invention and illustrated in FIG. 3;

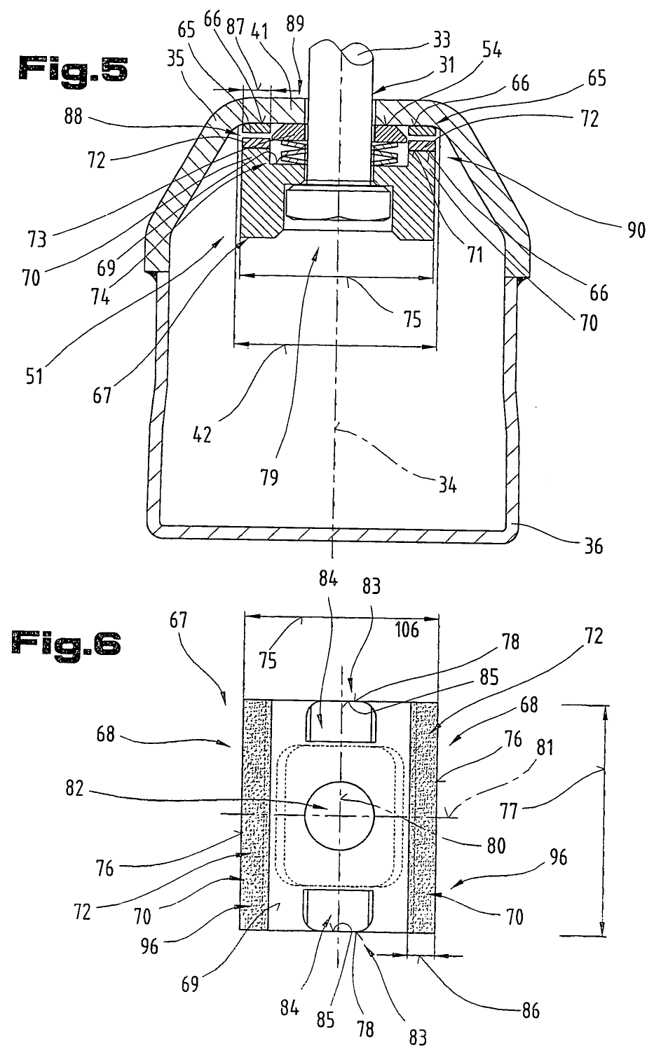

FIG. 5 is a highly simplified, schematic diagram showing the support element and fixing element in section along line V-V indicated in FIG. 3, from a front view;

FIG. 6 is a highly simplified, schematic diagram showing a plan view of the base element of the fixing element proposed by the invention;

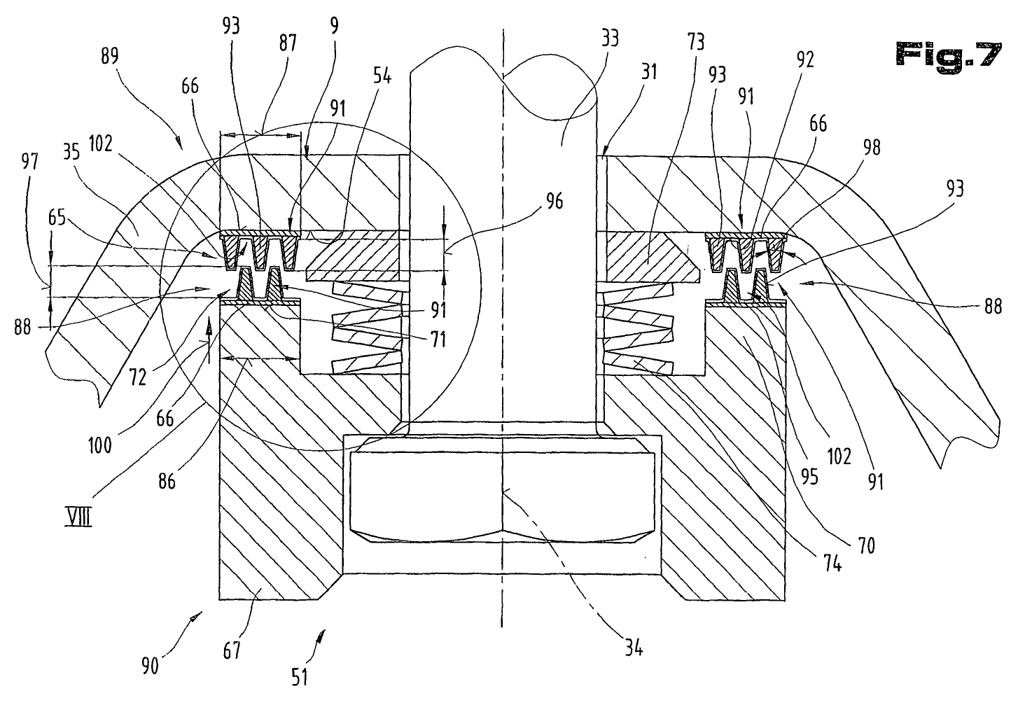

FIG. 7 is a highly simplified, schematic diagram showing a front view in section of a part-region of the support element with a coupling mechanism in a released, open position;

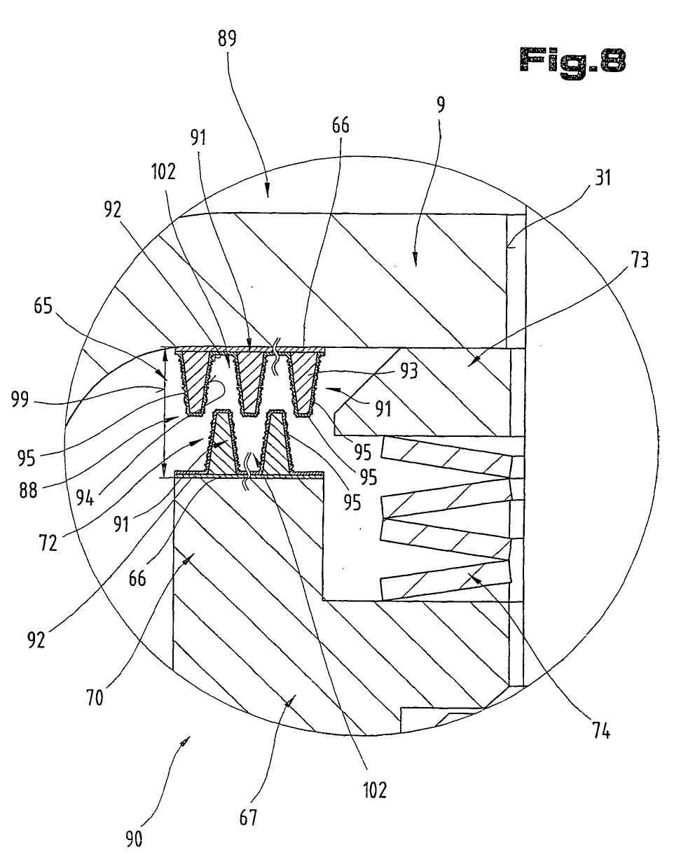

FIG. 8 is a highly simplified, schematic diagram showing a front view in section of a part-region of the fixing mechanism illustrated in FIG. 7, in particular the coupling mechanism, in a disengaged, released open position;

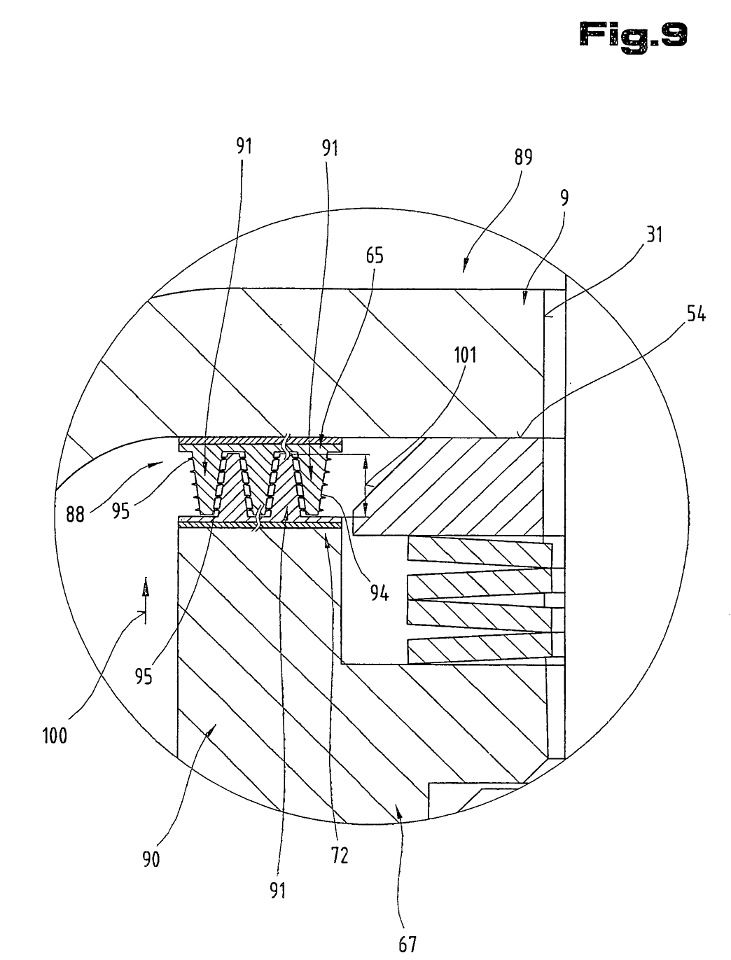

FIG. 9 is a highly simplified, schematic diagram showing a front view in section of another embodiment of the coupling mechanism of the fixing system with the coupling elements in a located fixing and locking position and in engagement;

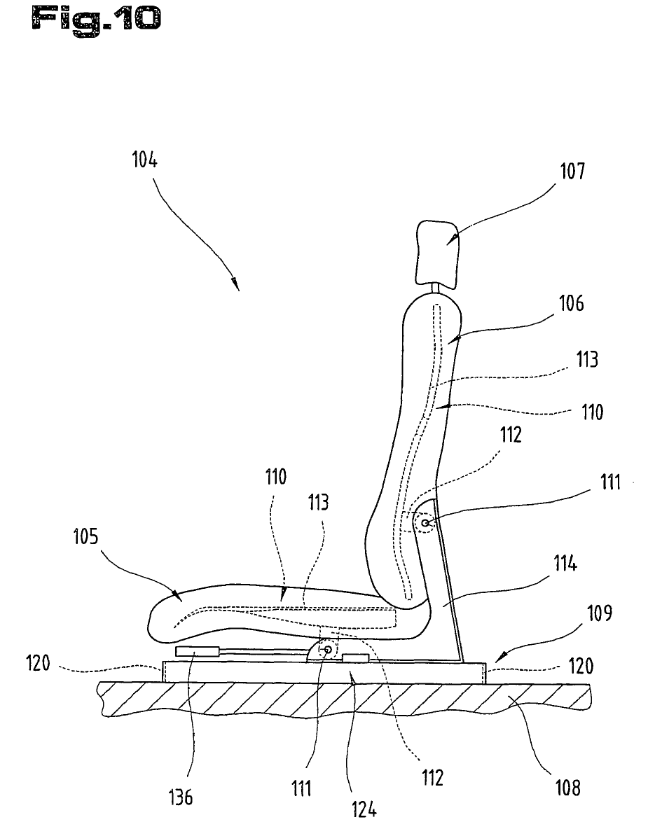

FIG. 10 is a highly simplified, schematic diagram showing a front view of a vehicle seat with a different embodiment of the adjusting mechanism and fixing system proposed by the invention;

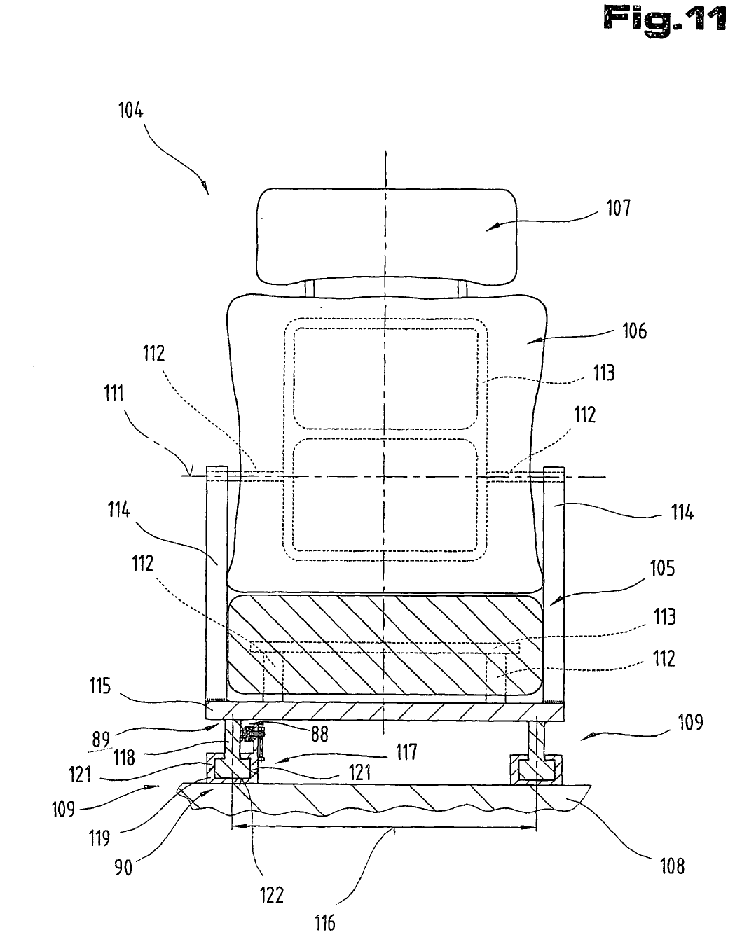

FIG. 11 is a highly simplified, schematic diagram showing a front view of the vehicle seat with fixing mechanism and adjusting mechanism, seen in section;

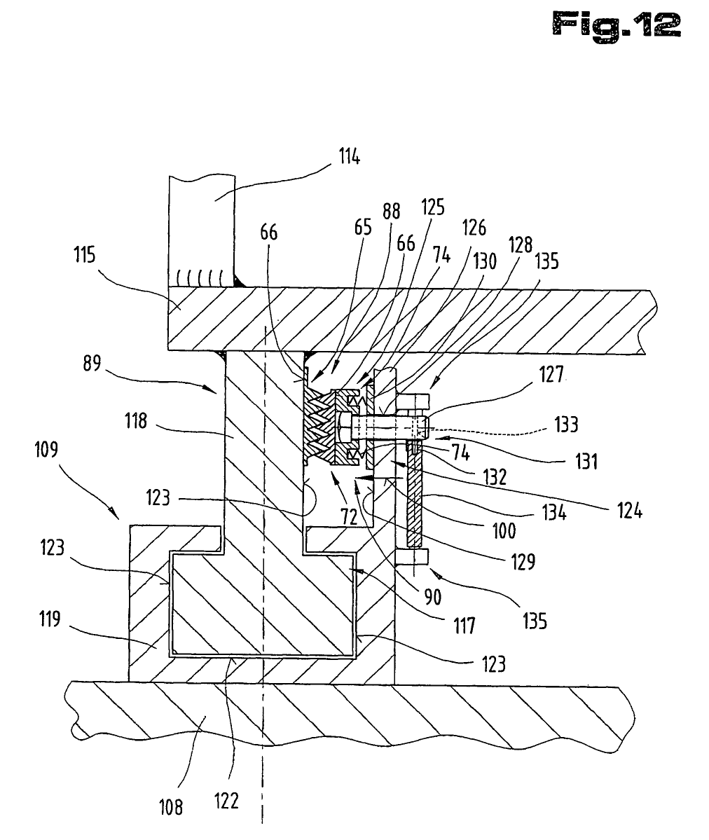

FIG. 12 is a highly simplified, schematic diagram, showing a front view in section of a part-region of the adjusting and fixing mechanism of the vehicle seat with a different embodiment of the coupling mechanism;

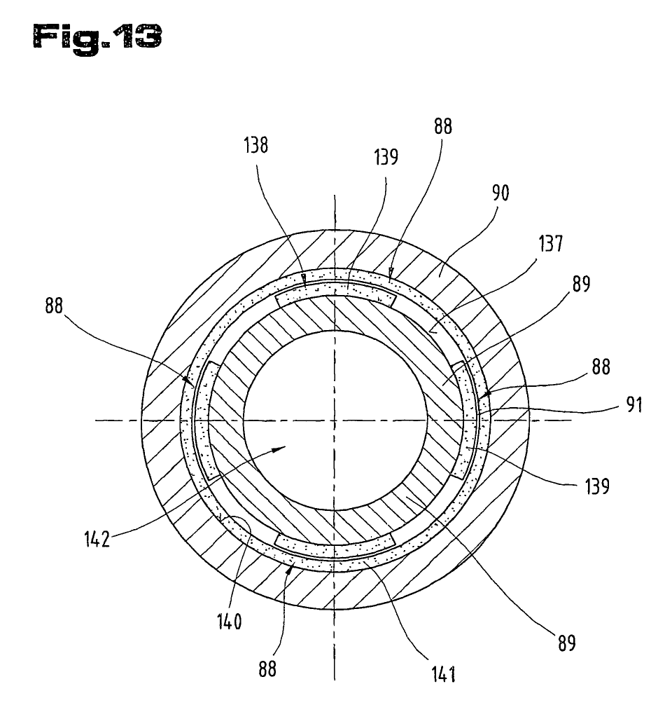

FIG. 13 is a highly simplified, schematic diagram showing a section of a different embodiment of the disengaged coupling elements of the coupling mechanism between two relatively adjustable and fixable parts;

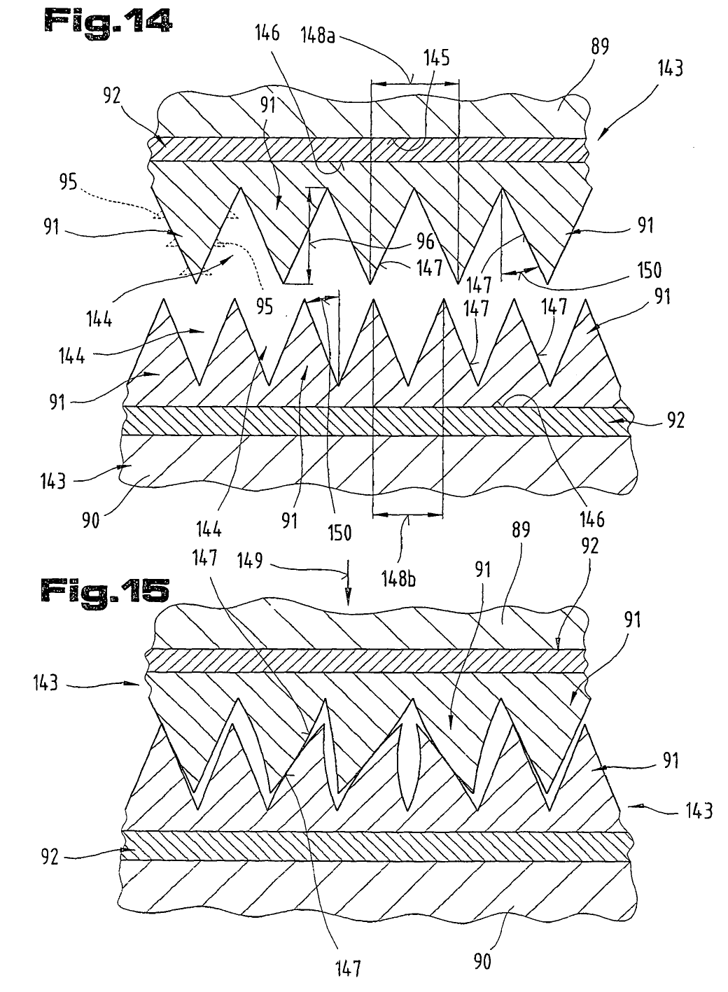

FIG. 14 is a highly simplified, schematic diagram in vertical section showing coupling elements as proposed by the invention attached to relatively adjustable parts in the disengaged state;

FIG. 15 is a highly simplified, schematic diagram showing a vertical section through coupling elements as proposed by the invention attached to relatively adjustable parts in an engaged state;

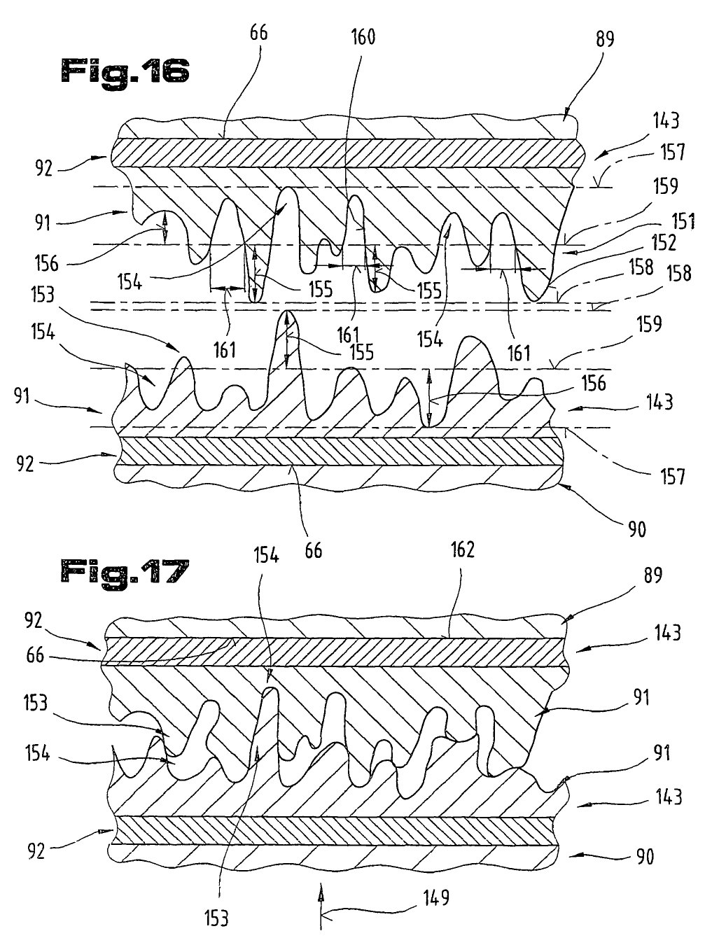

FIG. 16 is a highly simplified, schematic diagram showing a vertical section through coupling elements as proposed by the invention attached to relatively adjustable parts in the disengaged state;

FIG. 17 is a highly simplified, schematic diagram showing a vertical section through couplings elements as proposed by the invention attached to relatively adjustable parts in an engaged state.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIGS. 1 and 2, which will be described together, illustrate a steering shaft adjusting mechanism 1 with an adjusting mechanism 3 for varying the position of a steering shaft 2 and a fixing system 4 co-operating therewith for positioning the position of the steering shaft. The adjusting mechanism 3 for the steering shaft 2 has at least one mount 7 joined to a body 6 so as to be stationary by one or more fixing means 5, a profiled piece 8 enclosed in at least certain regions by the mount 7 and a support element 9 mounted on the profiled piece 8 so as to be longitudinally slidable. A base 10 of the mount 7,which has a multi-cornered and in particular U-shaped cross section, is disposed adjacent to the body 6 and is joined, releasably as necessary, to the body 6 by fixing means 5, in particular screws. The approximately U-shaped profiled piece 8 is disposed between the oppositely lying legs 11, which extend in the direction away from the base 10 of the mount 7 or body 6, and is preferably arranged rotated by 90° relative to the mount 7. The support element 9 is longitudinally guided between the oppositely lying profile legs 12 of the profiled piece 8 with a guide mechanism 13 provided between the profiled piece 8 and the support element 9.

The steering shaft 2 is longitudinally slidable relative to the mount 7, which is itself mounted so as to be stationary on a vehicle, in the direction of the longitudinal mid-axis 14—indicated by double arrow 15—and mounted so as to pivot in at least one radial direction relative thereto—indicated by double arrow. The steering shaft 2 is of a telescopic design and its position in the support element 9 is maintained or supported by bearings 19, 20 provided at oppositely lying end regions 17, 18. A length 21 of the support element 9 as measured in the direction of the longitudinal mid-axis 14 of the steering shaft 2 is longer than a length 22 of the profiled piece 8 and a length 23 of the mount 7. The profiled piece 8, which is mounted so as to pivot about a pivot axis 24 relative to the longitudinal mid-axis 14 of the steering shaft 2, has, on an internal face 25 directed towards the support element 9, a guide track arrangement 27 at least across a part of its length 22, which complements guide elements 26 co-operating therewith, such as guide bars, spherical guides, guide blocks, slide blocks, etc.. The guide elements 26 are joined to the support element 9 in a form-fitting and/or friction-locking arrangement, in particular are screwed, riveted, welded or bonded thereto, and extend at least across a pact of the length 21, in particular across the entire length 21, of the support element 9.

As may be seen by comparing FIGS. 1 and 2, at least one of the legs 11 of the mount 7 extending in the direction away from the body 6 has an orifice 30 which is curved in the radial direction relative to the longitudinal mid-axis 14, with a length 28 and a width 29, which is specifically convex towards the pivot axis 24, enabling an adjustment to be made—as indicated by double arrow 16. A clamping element 33 is provided, extending through a slot 31 of the support element 9 and a bore 32, in particular a guide bore, of the profiled piece 8 and the orifice 30 of the mount 7 along a mid-axis 34 disposed transversely to the longitudinal mid-axis 14 of the steering shaft 2. Naturally, several clamping elements 33 may also be used. As illustrated in this embodiment, the single-part or multi-part support element at least partially enclosed by the profiled piece 8 consists of a first part 35 and another oppositely lying part 36 joined to it. The parts 35, 36 to be joined to one another may naturally be joined by type of form-fitting and/or friction-locking connection known from the prior art, such as welding, bonding, brazing, screws, rivets, etc..

In the assembled state, the support element 9 has a profiled cross section. At least one of the two parts 35; 36, and expediently part 35 directed towards the internal face 25 of the profiled piece 8, has a slot 31 extending in a direction parallel with the longitudinal mid-axis 14 of the steering shaft 2. The first part 35 has a height 37 extending parallel with the mid-axis 34 and a wall thickness 38, whereby for practical purposes the height 37 is shorter and the wall thickness 38 greater than a height 39 and wall thickness 40 of the other part 36. The first part 35 has a trapezoidal cross section, for example, and a widthways dimension 42 at a base 41 lying opposite the other part 36 is shorter than a widthways dimension in the joining region 43 of the two parts 35, 36 to be joined to one another. The parts of side legs 44 disposed between the base 41 of the first part 35 and the joining regions 43 are inclined towards one another in the direction of the height 37 and the angle becomes wider, the farther they are away from the base 41 they are, forming intermediate parts which are inclined relative to the mid-axis 34, which are then adjoined by end parts extending parallel with the mid-axis 34. The parts of the side legs 45 between a base 41 of the other part 36 lying opposite the base 41of the first part and the joining region 43 initially extend parallel with the mid-axis 34 in the direction of the height 39, adjoining which are intermediate parts with a slight taper, which are in turn followed by end parts extending parallel with the mid-axis 34. Naturally any single-part or multi-part support element 9 known from the prior art may be used as the support element 9.

A base 46 of the profiled piece 8 incorporating the bore 32, in particular a guide bore, is disposed adjacent to the legs 11 of the mount 7 provided with the orifice 30, from which the profile legs 12 extend in a direction away from the legs 11 or base 46 on either side and parallel with one another. An orifice width as measured at the internal face 25 between the oppositely lying profile legs 12 is at least slightly larger than a maximum width at the outer periphery of the support element 9. For practical purposes, the profile legs 12 extend parallel with the mid-axis 34. Recessed into transition regions 47 between the base 46 and the profile legs 12 of the profiled piece 8 and extending at an angle to the mid-axis 34 are guide track arrangements 27 forming guide tracks 48, 49. As illustrated in this embodiment chosen as an example, the guide mechanism 13 is provided in the form of guide elements 26, arranged on the external surface in the region of the intermediate parts of the side legs 44 of the first part 35, in particular profiled strips, and the guide track arrangements 27 disposed on the internal face 25 in the transition regions 47 of the profile legs 8. Expediently, the guide element 26, in particular the profiled strip, has a multi-cornered, in particular trapezoidal cross section, in a plane perpendicular to its longitudinal extension. At least one of the guide tracks 48; 49, in particular the guide track 48, extends parallel with the longitudinal mid-axis 14 of the steering shaft 2, whilst the other guide track 49 extends at an angle, starting from the base 46, in the direction towards the profile leg 12 and becomes wider, the farther the distance in the direction of the profile leg 12. As a result of the guide mechanisms 13 spaced at a distance apart about the mid-axis 34 and inclined towards one another, the support element 9 is guided in the direction parallel with and perpendicular to the longitudinal mid-axis 14 during the process of adjusting the steering shaft 2 when the fixing system 4 is in the released state.

The fixing system 4 co-operating with the adjusting mechanism 3 has at least one, in particular two, adjusting devices 50, 51, which are received on the clamping element 33 so as to be prevented from rotating, and an operating lever 52 mounted so as to be pivotably displaceable by the clamping element 33. At least one adjusting device 51 is provided between the steering shaft 2 and the support element 9 and at least one other adjusting device 50 is provided between the mount 7 and the operating lever 52. The adjusting devices 50, 51 overlap at least certain regions of a bearing surface 53 of the leg 11 of the mount 7 and a bearing surface 54 in the region of the base 41 of the first part 35 of the support element 9. Disposed perpendicular to the mid-axis 34, the bearing surfaces 53, 54 extend parallel with one another. Between the adjusting device 50 co-operating with the mount 7 and the operating lever 52, one or more operating elements 55 with interlocking operating elements 55 are provided, which rotate one on the other and are mounted so as to be pivotably displaced by the clamping element 33, having tapering operating faces to enable a pivoting motion from a released disengaged open position into a fixing locking position in a direction perpendicular to the circumferential direction of the operating elements 55. In practical terms, one of the operating elements 55 is fixed to the adjusting device 50 so as to be displaced with it, whilst the other operating element 55 is fixed to the operating lever 52 so as to be displaced with it, in particular welded, brazed, screwed, riveted, etc.. As the operating lever 52 is pivoted from a located locking position into a disengaged open position, the adjusting devices 50, 51 are shifted into a released or disengaged, uncoupled open position due to the mutual support of the mutually facing operating faces of the oppositely lying operating elements 55 against the action of resilient return forces.

Naturally, any type of operating element 55 known from the prior art which is able to act against resilient return forces may be used, such as eccentric plates, cam plates, etc.. More details of the structure and operating mode of the fixing system 4 will be given with reference to the other drawings.

As may also be seen from FIG. 2, the clamping element 33 in its assembled position is positioned by means of a plastic plate 56 arranged between the profiled piece 8 and the support element 9 and a sheet metal plate 57 arranged on top of and parallel therewith. The metal plate 57 and the clamping element 33 may be joined by any type of form-fitting and/or friction-locking connecting elements known from the prior art. The operating lever 52, the operating elements 55 and the adjusting devices 50, 51 are disposed in a substantially clearance-free arrangement relative to one another, releasably fixed as necessary, in the longitudinal direction of the clamping element 33 by means of a fixing arrangement 58 provided on the free end of the clamping element 33, in particular a screw arrangement.

FIGS. 3 to 6, which will be described together, illustrate the support element 9 in longitudinal section and in cross section. The support element 9, which is expediently made up of several parts, is provided with semi-cylindrical bearing points 59, 60 at the oppositely lying end regions 17, 18 for receiving bearings, not illustrated in detail. As may be seen from this drawing, the semi-cylindrical bearing points 59, 60 extend concentrically about the longitudinal mid-axis 14 of the steering shaft, not illustrated in detail.

At oppositely lying end regions, a length 61 of the slot 31 is bounded by stop elements 62. Aligned transversely to the longitudinal mid-axis 14, the stop elements 62 have a bore accommodating a damping element 63. For practical purposes, the damping element 63 is made from a plastic material, in particular an elastomer. An adjustment path 64 bounded by the oppositely lying damping elements 63 is at least slightly shorter than the length 61 of the slot 31. The oppositely lying edges of the slot 31 act as end stops so that if the adjustment path 64 is exceeded, the adjusting device 51 briefly moves into abutment against one of the edges.

As may be also seen from FIG. 3, the bearing surface 54 of the first part 35 of the support element extending parallel with the longitudinal mid-axis 14 is provided with at least one, and in particular several, strip-shaped and flat coupling elements 65 extending parallel with one another in the longitudinal direction. For practical purposes, the coupling elements 65, in particular a flat support body thereof, are joined to the bearing surface 54 of the first part 35 so as to be stationary by means of an adhesive layer 66. A length of the coupling elements 65 is at least the same as, and expediently longer than, a length 61 of the slot 31.

FIGS. 4 and 5 illustrate a part-region of the adjusting device 51 and the support element 9. The adjusting device 51 preferably consists of a strip-shaped base element 67 with substantially prismatic longitudinal webs 70 oriented in the direction of its longitudinal extension on two oppositely lying longitudinal side regions 68 perpendicular to a base surface 69, the bearing surfaces 71 of which extending parallel with the base surface 69 are joined to other flat coupling elements 72, and at least one elastically deformable return element 74 disposed between a strip-shaped guide element 73 and the base element 67. In a located, fixing, locking position, a pressing force generated by at least one return element 74 is applied to the mutually locatable coupling elements 65, 72. The pressing force of the adjusting devices 50; 51 is applied to at least one of the coupling elements 65; 72. The adjusting device 50 is not illustrated in detail in FIGS. 4 and 5.

As may be seen more clearly from FIG. 6, the longitudinal webs 70 may be integrally formed on the base element 67 in a single piece or joined to it by means of a form-fitting and/or friction-locking connecting element. A width 75 of the base element 67 measured transversely to the longitudinal mid-axis 14 spaces two mutually parallel longitudinal side faces 76 apart from one other, extending perpendicular to transverse side faces 78 mutually spaced apart from one another by a length 77. In a bottom face 79 lying opposite the base surface 69 is a cut-out for providing a non-rotating mount for the clamping element 33. A longitudinal mid-axis 80 and a transverse mid-axis 81 extending perpendicular thereto form a common intersection for a bore 82 through which the clamping element 33 is inserted. The longitudinal mid-axis 80 extends parallel with the longitudinal mid-axis 14 of the steering shaft 2. At the distal end regions 83 of the base element 67, preferably in the peripheral region thereof and aligned perpendicular to its base surface 69, are substantially prismatic guide and/or stop elements 84, which project into the slot 31. A width of the guide and/or stop elements 84 is at least smaller than an orifice width of the slot 31. The side faces of the base element 67 disposed at right-angles to the longitudinal side faces 76 extend congruently with the stop surfaces 85 of the guide and/or stop elements 84, as may be seen from FIG. 6.

The width 75 of the base element 67 is expediently slightly smaller than the widthways dimension 42 in the region of the base 41 of the support element 9. The strip-shaped coupling element 72 is joined by means of an adhesive layer 66 to the bearing surface 71 of the longitudinal web 70. The base element 67 may co-operate with a strip-shaped coupling element 72 or several coupling elements 72 distributed across the base surface 69 of the base element 67. A coupling element width 86 of the coupling element 72 arranged on the base element 67 is expediently the same as a coupling element width 87 of the coupling element 65 cooperating with the first part 35 of the support element 9. Naturally, it would also be possible for one of the two coupling element widths 86; 87 to be bigger or smaller.

The strip-shaped guide element 73 supported on the return element 74 has a surface extending in a plane parallel with the bearing surface 54 of the first part 35. At its distal end regions incorporating the guide and/or stop elements 84, the guide element 73 has matching recesses so that the guide element 73 is accommodated between the guide and/or stop elements 84 and the oppositely lying longitudinal webs 70 in the widthways direction.

For the sake of simplicity, the adjusting device 50 is illustrated in FIG. 2 only, but the bearing face 53 of the leg 11 of the mount 7 directed towards the adjusting device 50 has at least one, in particular several, parallel coupling elements 65 spaced at a distance apart from one another in the longitudinal extension of the orifice 30. For practical purposes, the coupling elements 65 are spaced apart from one another by at least the width 29 of the orifice 30.

The mutually locatable coupling elements, 65, 72 form a coupling system 88, which may be releasable if necessary, between at least two, preferably flat parts 89, 90 or elements, which are adjustable relative to one another. The relatively adjustable parts 89, 90 constitute the adjusting mechanism 3. This being the case, the first part 35 of the support element 9 and the legs 11 of the mount 7—not illustrated in FIGS. 3 to 6—form a first part 89, whilst at least a part-region of the adjusting devices 50, 51, in particular the base element 67, forms the other part 90.

As in the preceding embodiments, the mount 7, the support element 9, in particular the first part 35, as well as the adjusting devices 50, 51, in particular the base element 67, are made from a metal and/or non-metal material, on the mounting surfaces or bearing surfaces 53, 54, 71 or base surface 69 of which coupling elements 65, 72 are provided, at least in certain regions.

FIGS. 7 to 9, which will be described together, show a part-region of the first part 89, in particular the support element 9, and the other part 90, in particular the base element 67, of the adjusting device 51, which can be located with one another via a coupling device 88. As described in detail above, the first coupling element or elements 65 are joined to the bearing surface 54 of the first part 89, in particular the first part 35 of the support element 9, by means of an adhesive layer 66.

The other coupling elements 72 lying opposite the coupling element or elements 65 are joined by the adhesive layer, in particular at the flat support body, to the bearing surfaces 71 of the longitudinal webs 70 of the other part 90, in particular the base element 67. As illustrated in this drawing, the coupling elements 65, 72 are disengaged and therefore in a released open position. The coupling elements 65 arranged in the longitudinal direction in a region bordering the slot 31 are spaced at a distance apart from one another in the widthways direction and extend parallel with one another and parallel with the slot 31. The coupling elements 65, 72 have several coupling parts 91, which are preferably spaced apart from one another in the direction of the coupling element width 86, 87, which extend perpendicular, starting from a preferably flat support body 92, in the direction of the base element 67. The coupling parts 91 are expediently arranged on a surface of the entire support body 92 of the coupling elements 65, 72 in rows in the direction of the length and/or coupling element width 87 thereof or diagonally offset from one another. The coupling elements 65, 72 therefore have a plurality of coupling parts 91 distributed across a bearing surface 53, 54, 71 or a support body 92, which essentially locate in a form-fit with one another in a fixing, locking position and releasably fix the parts 89, 90 in a relative position. At least one coupling element 65; 72 is provided with at least one adjusting element, in particular an electrical, mechanical, etc., actuator.

The coupling elements 65, 72, which are made by an embossing process for example, form recessed or hollowed coupling parts 91, in which the hollow core 93 of the support body 92 is expediently at least surface-coated and/or completely filled with reinforcing and/or strength-enhancing materials, in particular polymers. An external structured surface 94, in particular a locating surface or joining surface, of the flat support body 92 of the coupling parts 91 has a plurality of small, in particular microscopic, slightly elastically flexible, reversible projections 95. Naturally, the surface 94, in particular the locating surface or joining surface of the support body 92 of the coupling parts 91 may be made using a slightly elastically flexible and reversible coating.

At least part-regions of the surface 94 or locating surface, in particular the projections 95, are of an elastically flexible design, whereas their core 93 may be made in a flexible or rigid design. The coupling elements 65, 72 are joined to the first part 89 and to the other part 90 by the adhesive layer 66, at least in certain regions.

The coupling parts 91 may naturally be of any geometric shape known from the prior art, such as triangular pyramids, regular polygons, frustoconical bodies, etc., If necessary, they may also be of a thread-type design.

For more detailed information about the different designs of coupling parts 91 of the coupling elements 65, 72, reference may be made to the more detailed disclosures made in patent specification WO 97/13981 A on this subject matter.

As illustrated in FIG. 7 and FIG. 8, the coupling parts 91 are in the shape of a truncated cone, the bigger cross-sectional surface of which sits close to the support body 92, whilst the smaller cross-sectional surface lying opposite it is close to the base element 67. A minimum height 96; 97 of one of the coupling elements 65; 72 is at least slightly bigger than a maximum height 97; 96 of the other coupling element 72; 65. As may be seen from this drawing, the minimum height 96 of the coupling element 65 is at least slightly bigger than a maximum height 97 of the coupling element 72. An acceptance angle 98 is bounded by the surface of the coupling parts 91. When the coupling elements 65, 72 are in a located fixing, closed position a distance 99 between the oppositely lying parts 89; 90 is at least slightly bigger than the maximum heights 96, 97 of the coupling parts 91. Consequently, there is no contact with the flat support body 92 which might otherwise damage the coupling parts 91.

The coupling elements 65, 72 may naturally be made from any thermoplastic materials-plastomers containing polyolefins known from the prior art, such as polypropylene, polyethylene and/or polyethylene copolymer, for example. Naturally, it would also be possible to use mixtures of polypropylene and/or polyethylene, for example with a high or low molecular weight. Another option would be to use thermoplastic materials-plastomers containing polyvinyl chloride (PVC), polyamide (PA), such as nylon, polystyrene, polyester, for example.

A height of the return element or elements 74 is bigger than the height 97 of the coupling parts 91 of the other part 90. At this stage, it should be pointed out that the return elements 74 may naturally be provided by any means known from the prior art, such as helical springs, plate springs, resilient rubber elements or resilient plastics.

The height 96; 97 of the coupling parts 91 is between 0.2 and 8 mm, in particular between 0.8 and 4 mm, for example 2 mm. A diameter at the larger cross-sectional surface of the coupling part 91 is between 0.1 mm and 4 mm, in particular between 0.4 and 1 mm, for example 0.8 mm. A diameter as measured at the smaller cross-sectional surface of the coupling part 91 is between 0.05 and 3 mm, in particular between 0.1 and 2.5 mm, for example 0.5 mm. The acceptance angle 98 between external lines at the surface 94 of the coupling parts 91 is between 5° and 40°, in particular between 10° and 30°. A distance between two or more adjacent coupling parts 91 more or less corresponds to the dimensions of the coupling part 91 projecting out in a receiving region.

For more details as to how these dimensions of the coupling parts 91 of the coupling elements 65, 72 are selected, reference may be made to the more detailed disclosures made in patent specification WO 97/13981 A in respect of this subject matter.

On the bearing surface 53 of the first part 90, in particular the mount 7, at least one, in particular several, coupling elements 65 are likewise provided, in the longitudinal extension of the orifice 30 and extending parallel with the orifice 30, the length of which is longer than the length 28 of the orifice 30.

FIG. 9 illustrates a different embodiment of the coupling mechanism 88 between the first part 89, in particular the support element 9 and/or the mount 7—not illustrated in detail—and the other part 90, in particular the base element 67. Spaced apart from one another in the lengthways and/or widthways direction of the coupling elements 65, 72, the coupling parts 91 have a frustoconical cross-sectional shape with at least one, in particular several, projections 95 extending round the periphery of the surface 94 spaced apart from one another in the longitudinal direction. The projections 95 are polygonal in shape in particular triangular, trapezoidal, etc.. The projections 95 standing proud of the surface 94 preferably have a height and width in the range of between 5 μm and 450 μm, in particular between 250 μm and 400 μm. Side faces of the elastically flexible projections 95 converge, tapering in a radial direction, the greater the distance, for example. As may be seen from this drawing, the coupling elements 65, 72 are respectively integral and of the same material. For practical purposes, the two coupling elements 65, 72 are made from the same material, in particular thermoplastic polymers. Naturally, it would also be possible for one of the two coupling elements 65, 72 to be made from a plastic material of a different strength and/or toughness, in particular thermoplastic polymers.

It should also be pointed out that the support element 9, the mount 7 and the profiled piece 8 may me made in a single piece or several pieces from ferrous metal or non-ferrous metal or plastics, such as PVC or PA, for example. Naturally, these components made from metal or non-metal materials may additionally be provided with a coating of plastics. The coupling elements 65, 72 may naturally be joined to the respective components by any joining process or joining means known from the prior art, such as welding, bonding, or optionally rivets, screws, etc..

The design of the mutually locatable coupling parts 91 of the coupling elements 65, 72 enables the coupling mechanism 88 to be used as an energy-absorbing deformation system or safety system. By using appropriate materials, in particular with a high toughness and/or strength, for the coupling parts 91, in particular their projections 95, cores 93 or the coupling parts 91 themselves, energy generated as a result of any deformation which occurs in the coupling parts 91 and/or the projections 95 and/or cores 93 due to the force acting in the longitudinal direction of the steering shaft and/ or in a direction extending transversely thereto can be absorbed. As was the case with the drawings above, the coupling parts 91 may be provided with the cores 93, which specifically have a property enabling them to absorb a high amount of energy. The advantage of this embodiment primarily resides in the fact that even forces or energy occurring in the longitudinal direction of the steering shaft and/or in a direction extending transversely thereto as a result of an accident can stop or largely prevent the steering shaft and a steering wheel from lifting in a direction perpendicular to the longitudinal extension of the steering shaft. Consequently, the risk to which the vehicle passengers are exposed due to shifting or lifting of the steering wheel can be significantly reduced.

It is also of advantage to use a plastic material for the support element 9 and/or the mount 7, because the coupling elements 65 can be extruded in one or optionally several production processes onto a main body made from plastic. This being the case, the coupling element 65 can be extruded onto the profiled support element 9, which is expediently made in a single piece, or the mount 7 in one and the same work process. The calibrated and cooled, dimensionally stable support element 9 or mount 7 is heated in a surface region where the coupling elements or elements 65 are to be applied, after which the coupling element or elements 65 are extruded onto the heated region.

In another embodiment, the support element 9 or the mount 7 is heated to such a degree in the region in which the coupling element 65 is to be welded on that the surface region melts. Support elements 9 or mounts 8 of this type, made by the co-extrusion principle, may be calibrated during or after the extrusion process, to ensure that they are made to a sufficient degree of accuracy. Naturally, these components may optionally also be encased in a resistant and chemically resistant protective coating, either in at least parts of their surface or over the entire surface, thereby enabling the stringent requirements of the automotive industry to be met. A method of this type and the plant and machinery needed to implement this method of producing a profiled component, such as the support element 9 or mount 7 are already generally known from the prior art and do not constitute part of the subject matter of this application. Naturally any other method and equipment known from the prior art may be used to make the profiled components. The materials which might be used for the mount 7 and the support element 9 will preferably be polyvinyl chlorides (PVC) and high-strength polyvinyl chlorides or polyamides. The high-strength polyvinyl chlorides will primarily be used to strength part-regions or the entire component, to render it capable of withstanding high stress, such as temperature, chemical reactions, etc..

In another embodiment, the part or parts 89; 90 and the coupling elements 65; 72 are made from a metal material and the metal coupling parts 91 themselves have elastically flexible projections 95. The coupling parts 91 of the coupling elements 65; 72 are made by an embossing or erosion process. The surface 94 produced as a result may optionally be coated with a plastic material which has an intrinsic elasticity. The dimensions of the coupling parts 91, such as height, diameter, angle, width etc., substantially correspond to the dimensions of the coupling parts 91 made from plastic 91. Naturally, the core 93 may also be made from a metal material, the surface 94 of which is covered with a layer of plastic material. Another possibility is to provide metal coupling elements 65; 72.

How the adjusting mechanism operates:

When a position has to be adjusted and fixed, the operating lever 52 is operated to release an adjustment direction—indicated by arrow 100—of the adjusting devices 50, 51, which are displaceable relative to one another, in the longitudinal extension of the clamping element 33 and the latter are respectively moved back by a same adjustment path 101. Naturally, the spring constants of the return elements 74 of the adjusting devices 50, 51 can be selected so that the coupling mechanisms 88 of the fixing system 4 are brought into engagement simultaneously or, alternatively, the other coupling mechanisms 88 are located after the first coupling mechanisms 88 have been brought into engagement. Accordingly, at least one and expediently several mutually spaced coupling parts 91 of a first coupling element 71 is or are brought into engagement in the direction of the adjustment direction—indicated by arrow 100—with another oppositely lying coupling element 65 incorporating at least one, in particular several coupling parts 91. Consequently, each coupling element 65, 72 expediently has a plurality of receiving regions 102 between mutually spaced coupling parts 91 which are expediently distributed uniformly across the support body 92. In a located, fixing, locking position, at least one associated oppositely lying coupling part 91 projects into and engages with this receiving region 102 of the coupling elements 65, 72. For practical purposes, at least one coupling part 91 engages with several respective mutually spaced coupling parts 91 in a form-fit arrangement. At the same time, the surfaces 94 of oppositely lying coupling parts 91 are pressed against one another with at least a slight friction-locking action if necessary in the direction of the adjustment direction—indicated by arrow 100. By selecting the dimensions accordingly, the coupling parts 91 may be at least lightly clamped to one another as they are pressed one against the other. In the located, fixing position—as illustrated in FIG. 9 showing a different embodiment of the coupling elements 65, 72—the coupling elements 65, 72 and their coupling parts 91 and hence also the parts 89, 90 are held in position relative to one another, substantially without any clearance, in the direction parallel with the bearing surface 53; 54; 71 and releasably fixed.

In the located, fixing, locking position, the support element 9 and the mount 7 are releasably fixed in their relative position against the action of the elastically deformable return element or elements 74 by means of a plurality of elastically flexible, reversible projections 95 and the elastically flexible, reversible surfaces 94 of the locatable coupling elements 91. The adjustment path 101 must be overcome by the interlocking operating elements 55 mounted on the clamping element 33, in particular a clamping bolt. For practical purposes, the adjustment direction—indicated by arrow 100—extends parallel with the mid-axis 34 of the clamping element 33 disposed perpendicular to the longitudinal mid-axis 14 of the steering shaft 2. It should be pointed out at this stage that the adjustment direction illustrated in the drawings—indicated by arrow 100—corresponds to an engaged position whilst the opposite direction corresponds to a released position, although this is not specifically indicated.

In a released, disengaged open position—as illustrated in FIGS. 7 and 8 for one embodiment of the coupling elements 65, 72 illustrated as an example—a pre-definable contact force is applied along the surfaces 53, 54 of overlapping guide elements 73 by the expediently clamped return elements 74 of the adjusting mechanisms 50, 51 so that an operator only has to apply light forces in order to adjust a steering wheel position. In order to switch from a located, fixing locking position to a disengaged released open position, it is necessary to overcome the adjustment path 101 in a direction parallel with the mid-axis 34 and in a direction opposite the support body 92 of the coupling elements 65 of the support element 9 and mount 7, in order to disengage the interlocking coupling parts 91. During the opening process with the operating lever 52, it is necessary to overcome only the force, in particular the contact force, prevailing between the interlocking coupling parts 91, since the clamped return element 74 reduces a force needed to open the mutually fixed components, such as mount 7, profiled pieces 8, support elements 9.

During the fixing process, the spring force of the return elements 74 of the adjusting devices 50, 51 must firstly be overcome and then a slight increase in force applied once the coupling elements 65, 72 are engaged since mechanical forces, in particular contact forces and/or deformation forces have to be overcome in addition during the continued movement in the adjusting direction—indicated by arrow 100—between the respective mutually locatable coupling parts 91. The force needed for releasing purposes may therefore be less, by the amount of clamping force in the return element 74, than a force needed for fixing purposes for which a further clamping force must additionally be overcome. It should be pointed out that the adjustment direction shown in the drawings—indicated by arrow 100—corresponds to a closing motion and an adjusting direction opposite the closing motion corresponds to an opening motion. The adjusting direction—indicated by arrow 100—for engaging or releasing the locatable coupling elements 65, 72 extends at least at an incline to the bearing surface 53; 54; 71, in particular perpendicular to the bearing surface 53; 54; 71 or to a force-transmitting direction if there is one—indicated by double arrow 103 in FIG. 3 for example. Consequently, the coupling mechanism 88 disposed between the parts 89; 90 is suitable for transmitting higher forces and/or torques in a direction parallel with the bearing surface 53; 54; 71 or in an inclined direction. One or more coupling mechanisms 88 may naturally be provided between the relatively adjustable parts 89, 90 one after the other and/or adjacent to one another.

FIGS. 10 to 12, which will be described together, are highly simplified, schematic diagrams snowing different views of an adjustable vehicle seat 104. The vehicle seat 104, comprising a seat part 105, a back part 106 and a head rest 107, engages with a guide mechanism 109 which is releasably attached to a body part 108, in particular a vehicle floor. The seat part 105 and the back part 106 have at least one reinforcing insert 110 each and each of the reinforcing inserts 110 is mounted so as to be pivotable about a pivot axis 111 extending transversely to the longitudinal direction of the vehicle. Accordingly, the pivot axes 111 are linked to one another by the reinforcing inserts 110 of the seat and back parts 105, 106 via a pivot part 112. The reinforcing inserts 110 are of a frame-type design or a flat or skeletal shape, for example, joined at their pivot parts 112 to reinforcing elements 113 spaced at a distance apart from one another in the widthways direction of the seat part 105 and back part 106. The reinforcing inserts 110 may naturally be of a single-piece or multi-part design and may be made from non-metallic materials or plastics, such as plastic reinforced with glass fibres, etc.. Spaced apart from one another in the widthways direction of the vehicle seat 104 are approximately L-shaped support elements 114, which between them bear the seat part 105 and the back part 106 in a pivoting arrangement. To this end, the seat part 105 and back part 106 are joined to the support elements 114 by a rod-type bearing element so as to be pivotable 114.

The support elements 114 are expediently joined to one another by mutually spaced transverse tracks 115 extending between the support elements transversely to the longitudinal direction. The transverse tracks 115 are disposed adjacent to the body part 108. In the longitudinal extension of the vehicle, between the transverse tracks 115 and the body part 108 and spaced apart from one another relative to the width of the vehicle are rail-type guide mechanisms 109. The guide mechanisms 109 spaced apart by a width 116 have at least one coupling mechanism 88 between at least two relatively adjustable parts 89, 90 forming an adjusting mechanism 117. The first part 89 is provided in the form of a rail-type guide part 118 and the other part 90 in the form of a guide part seating 119. The guide part 118 and the vehicle seat 104 joined to the guide part 118 so as to be fixed therewith in displacement is slidable lengthways in the longitudinal direction of the guide mechanisms 109. The adjustment path or displacement path of the vehicle seat 104 along the guide mechanism 109 is restricted by stop elements 120 provided at the distal end regions of the guide mechanisms 109. The guide part seating 119 enclosing the guide part 118 in an approximately C-shaped arrangement has oppositely lying lateral guide tracks 121 and height guide tracks 122 extending perpendicular to the lateral guide tracks 121. The guide parts 118, which have a substantially T-shaped cross section, and the vehicle seat 104 joined to the guide part 118 so as to be fixed in displacement therewith is guided in the longitudinal direction of the vehicle and in a transversely extending direction essentially without any clearance. The guide part seatings 119 are joined to the body part 108, in particular the vehicle floor, so as to be stationary. The coupling mechanisms 88 are disposed between the longitudinal side faces which extend parallel with the lateral guide tracks 121 of the guide part seatings 119 forming bearing surfaces 123 and the guide part seatings 119. The first coupling element 65 is joined by an adhesive layer 66 etc. in a form-fitting and/or friction-locking arrangement to the longitudinal side faces of the guide part 118 constituting a bearing surface 123. The coupling element 65 extends across at least a part of the length and expediently across the entire length and across at least a part region of the height of the guide parts 118.

The schematic diagram given in FIG. 12 illustrates the guide mechanism 109 on an enlarged scale. A fixing system 124 co-operating with the adjusting mechanism 117 has at least one coupling mechanism 88 constituting a different embodiment of the coupling mechanism 88, which has at least two locatable coupling elements 65 and 72. The coupling element 72 is joined by an adhesive layer 66 etc. to an adjusting device 125 constituting the part 90, which is provided with at least one elastically flexible return element 74. The part 90 is provided in the form of a strip-shaped support part. The return element 74 may naturally be provided by any type of elastically flexible elements known from the prior art, such as a helical spring, rubber spring elements, etc. A retaining part 126 of the guide part seating 119, which is preferably integral with and made from the same material as the guide part seating 119, preferably has a substantially rectangular cross section and preferably extends across a part-region of the length and height of the guide part 118. A clamping element 127 aligned with the adjustment direction—indicated by arrow 100—is retained in a guide bore 128 by the retaining part 126 so as to be guided in a longitudinal sliding arrangement. A longitudinal side face of the retaining part 126 directed towards the bearing surface 123 of the guide part 118 and constituting a bearing surface 129 forms a guide track for a strip-shaped guide element 130 received by the clamping element 127. The elastic or automatically reboundable return element or elements 74 is or are retained in position in bores in the part 90 or support part disposed parallel with the longitudinal extension of the clamping element. The return elements 74 are slightly biassed. Expediently, a protrusion or head of the clamping element 127 is arranged in a recess disposed in the support part so as to be prevented from turning. For practical purposes, the support part and the guide element 130 are strip-shaped. A free end 131 of the clamping element 127 is provided with a bore 133 through which a connecting element 132 is inserted.

An oblong lever 134 with a rectangular cross section and one or more right-angled bends is retained and mounted so as to pivot by means of two bearing points 135 in its longitudinal extension, disposed on the guide part seating 119 spaced apart from one another by a distance equal to the height of the lever 134. The bearing points 135 are expediently joined to the guide part seating 119 in a form-fitting and/or friction-locking arrangement. Although not illustrated, the mid-axis of one of the bores in the bearing points 135 for inserting a bolt forms the pivot axis about which the lever 134 is pivoted. At an end region lying opposite the handle part 136 of the lever 134, the lever is articulatingly linked to the connecting element 132, which extends through the bore 133 of the clamping element 127. To this end, the lever 134 has a blind bore in this end region, through which the connecting element 132, in particular a bolt, extends.

When the lever 134 is not being operated, the fixing system in particular the coupling elements 65 and 72 of the coupling mechanism 88, automatically engage, in which case the relatively adjustable parts 89, 90 are releasably fixed to one another in their adjusted relative position relative to the body part 108. When the lever 134 is operated in the direction towards the guide mechanism 109, the engaged coupling elements 65, 72 are moved apart and disengaged from one another against the action of elastic return elements 74. As long as the lever 134 is being operated, a relative displacement can be effected between the relatively adjustable parts 89, in particular the vehicle seat 104, with respect to the other part 90 which is stationary on the body part 108, in particular the guide part seating 119, in the longitudinal direction of the vehicle.

Naturally, the different embodiments of the coupling elements 65, 72 described in the preceding embodiments may also be used in this application. Furthermore, the design of the adjusting mechanism 117, as well as the fixing system 125 co-operating with the adjusting mechanism 117 is described merely as an example of an embodiment.

The coupling mechanism 88 may also be used in vehicle seats 104 which can be pivoted radially to the longitudinal direction of the guide mechanism 109. A coupling mechanism 88 of this type may also be used to fix a position of an arm rest of the vehicle seat 104.

In another embodiment, not illustrated the coupling mechanism 88 proposed by the invention is disposed between the back part 106 forming the first part 89 and the support element 114 forming the other part 90 as a means of releasably fixing the relative position of the back part 106 with respect to the seat part 105. For practical purposes, one of the coupling elements 65 is joined to the support element 114 in a form-fitting and/or friction locking arrangement and the other coupling element 72 is preferably joined in a form-fitting and/or friction locking arrangement to the reinforcing element 113 integrated in the back part 106. At least one of the coupling elements 65; 72 is provided with at least one adjusting mechanism, in particular a mechanical or electrical actuator, for engaging or disengaging the locatable coupling elements 65, 72. This will then provide an easy means of being able to releasably fix a set inclination of the inclination adjusting mechanism of a vehicle seat 104, an armchair or bench, etc., for example., by providing at least one coupling mechanism 88.

Naturally a coupling mechanism 88 of this type may be provided between the head rest 107 and the back part 106, in which case a set height of a height adjusting mechanism for the head rest 107 can be releasably fixed. This being the case, one of the coupling elements 65; 72 can be joined to the reinforcing element 113 of the back part 106 and the other coupling element 72 can be joined to at least one of the guide elements of the head rest 107.

In another embodiment, not illustrated, where the coupling mechanism 88 is provided between two relatively adjustable parts 89, 90, the coupling mechanism 88 for releasably fixes a set height and/or inclination of a height and/or inclination adjusting mechanism for an armchair, in particular a desk chair.

In another embodiment, such as illustrated in FIG. 13, two tubular parts 89, 90 are provided, nested one inside the other, and one of the two parts 89, 90, in particular the part 89 lying on the inside, is of an elastically deformable design. The inner part 89, which is air tight, is closed off from the ambient air in an airtight arrangement and has a pre-definable intrinsic stiffness. The part 89 has a connecting line, not illustrated, providing a connection to a working medium, in particular air, liquid, etc., and can be alternately pressurised.

The inner part 89 has an outer periphery forming a bearing surface 137 in at least certain regions, in the form of segments 138 with coupling elements 139 and an inner periphery of the outer part 90 forming a bearing surface 140 directed towards the outer periphery 137 of the inner part 89 has a flat coupling element 141. The pressure applied to a cavity 142 of the inner part 89 causes a radial widening of the latter, producing a form-fitting engagement of the mutually facing coupling parts 91 of the coupling elements 139, 141 and thus fixes the relative position of at least two relatively adjustable parts 89, 90.

The parts 89, 90 may be a moulded tube and a flexible pipe element, for example.

If the over-pressure prevailing in the cavity 142 is adjusted to ambient pressure or if it is switched to a pressure blow atmospheric pressure, in particular is reduced to a vacuum pressure, the elastically flexible part is returned to its original initial state. The coupling elements 139, 141 are then totally disengaged. The advantage of this solution primarily resides in the fact that it enables a pre-definable relative position of the parts 89, 90 to be fixed and locked by a rapid cycle time which is exclusively dependent on the cycle time needed to apply the pressure. The part 89 with a pre-definable intrinsic stiffness or elasticity resumes its original position when ambient pressure prevails in the cavity 142. As a result of the small dimensions of the coupling parts 91, only a short adjustment path is needed in the radial direction towards the parts 89; 90.

Naturally, if using a support body with an elasticity for the coupling element 139, it will extend across the entire outer periphery of the tubular part 89.

At least part regions of one of the tubular parts 89, 90, in particular the inner part 89, is designed to be elastically deformable in a radial direction towards the bearing surface 139; 140. The part 89 has a line connection via a connecting line to an adjusting mechanism, in particular a pneumatic or hydraulic actuator, in order to pressurise the cavity 142.

In order to engage or disengage the locatable coupling elements 139, 141, at least one of them is pressurised alternately in a radial direction towards the bearing surface 137, 140.

In another embodiment, not illustrated, the coupling mechanism 88 is arranged between two relatively displaceable parts 89, 90 and the coupling mechanism 88 is used to releasably fix a set height of a belt height adjusting mechanism.

As with the embodiments described above, only manually operated adjusting mechanisms 3; 117 and the fixing systems 4; 124 co-operating with them are illustrated. This type of adjusting device 50; 51; 125 for the fixing systems 4; 124, in particular the coupling mechanism 88 between two relatively adjustable parts 89, 90 could naturally also be operated by electric, pneumatic or hydraulic actuators. The actuator drives may have flat slide tracks, adjusting elements, etc., in a working connection with the coupling elements 65; 72, which move one of the coupling elements 72 into engagement with the other coupling elements 65 once pressure, force, torque or current is applied. Actuators of this type used for the fixing system 4; 124 and adjusting mechanism 3; 117, which are controlled and regulated by at least one control system and at least one operating system, are generally known from the prior art and do not form part of the subject matter of this application.

In another embodiment, not illustrated, when the weight of a seat occupant is detected, at least one other fixing system 4, in particular another adjusting mechanism 50; 51, is optionally connected in series between the operating lever 52 and the mount 7 and between the steering shaft 2 and the support element 9 in the direction of the steering shaft 2 or is connected in parallel transversely to the steering shaft 2. Naturally, this approach may also be used with all the other embodiments. The specific advantage of this is that under the action of a force or energy in the longitudinal direction of the steering shaft 2 and/ or in a direction transversely thereto, the contact force and the force for fixing the steering shaft 2 relative to the mount 7 is increased, thereby making it more difficult for the steering shaft 2 to slide in its longitudinal direction or preventing it altogether, so that a higher proportion of energy can be absorbed.

FIGS. 14 and 15, which will be described together, illustrate another embodiment of the coupling elements 143, which are shown in the disengaged position in FIG. 14 and in the mutually located position in FIG. 15. The mutually locatable coupling elements 143 are made from a single piece or multiple parts or have a single layer or several layers and their coupling parts 91 are at least slightly elastically flexible and reversible, and bearing regions 144 are provided between them for at least one other coupling part 91 formed by the other coupling element 143. As illustrated in this preferred embodiment, the coupling parts 91 have a pyramid-shaped or conical cross section. The coupling parts 91 of the coupling elements 143, which have an inherent elasticity and are distributed along a surface 145, preferably uniformly. are elastically and reversibly deformable in three spatial directions and when pressure is applied at least one coupling element 143 is forced and/or pushed back on its self and elastically deformed in the direction of the bearing region 144 of the other coupling element 143. The surface 145 forms a locating surface co-operating with the bearing surface 53; 54; 71; 123; 129; 137; 140—not illustrated in this drawing—for receiving the coupling element 143 in position. Naturally, the bearing surface 53; 54; 71; 123; 129; 137; 140 may be recessed in the part 89; 90, in which case the coupling parts 91 of the other coupling element 143 project into this recess, in order to engage.

The coupling elements 143 are preferably respectively joined to the parts 89, 90 by an adhesive layer 66—not illustrated. As illustrated in this embodiment shown as an example, the coupling element 143 is provided with a flat support body 92 disposed between the coupling parts 91 and the surface 145, on which the coupling parts 91 are distributed, preferably uniformly, at a support body surface 146 remote from the surface 145 forming a connecting surface. The support body forming the integral coupling element 143 with the coupling parts 91 may have properties that are the same as or different from the coupling parts 91 in terms of toughness, strength, etc.. The coupling parts 91 distributed along the support body surface 146 of the support body, preferably uniformly, are bounded by side faces forming support faces 147 starting from the support body surface 146 and converging with one another in the opposite direction. The coupling parts 91 may naturally be provided with bead-shaped projections 95 standing proud of the support surface 147—as indicated by broken lines—which are spaced at least slightly apart from one another in the direction of the height 96 of the coupling parts 91. Clearly, in the region of a profiled surface or the support surfaces 147 of the coupling parts 91 forming it, it would also be possible to provide an elastically flexible and reversible coating totally covering it, although this is not illustrated. This layer may be made from a plastic material with different properties from the coupling parts 91. In practical terms, the layer is made from a material with a higher elasticity, in particular a plastic material. The layer itself expediently has a wave-shaped mating or profiled surface.

As may be seen from FIG. 14, the oppositely lying coupling elements 143 may have different separating distances 148a, 148b between two couplings parts 91 of the coupling element 143 arranged one immediately after the other, so that the oppositely lying part-regions of the coupling elements 143, in particular the coupling parts 91, which can be brought into engagement with one another are deformed when a pressure or force is applied—as indicated by arrow 149—by at least one of the parts 89; 90, as may be seen from FIG. 15. The pressure or force which may be applied—as indicated by arrow 149—if necessary by adjusting devices 50, 51 may be provided by any electric, hydraulic, pneumatic or hybrid actuators known from the prior art.

Naturally, another possibility would be for the mutually locatable coupling elements 143 to have an identical separation 148a, 148b but a different number of coupling parts within the same length. This shift or offset of at least one bearing region from at least one coupling part 91 results in an enhanced form-fitting and/or friction locking action between the coupling elements 143 in the lengthways and/or widthways direction of the flat locatable coupling elements 143. If one of the separating distances 148 of the locatable coupling elements 143 is bigger or smaller, several coupling parts 91 of the oppositely lying coupling element 143 may optionally be forced simultaneously into the bearing region 144 in which the support surfaces 147 slide against one another as the coupling parts 91 of the locatable coupling element 143 interlock. In order to make it easier for several coupling parts 19 of a coupling element 143 to be forced into one bearing region 144 of the other coupling element 14, the flank angles 150 may be of a different inclination. It would, of course, also be possible for the side flank 150 of the coupling parts 91 of the oppositely lying coupling elements 143 to have an identical inclination, in which case several coupling parts 91 separated from one another by the bearing region 144 project into the oppositely lying bearing region 144 of the other coupling element 143 when pressure or a force is applied—as indicated by arrow 149 and as pressure continues to be applied—indicated by arrow 140—the inclined support surfaces 147 are elastically and reversibly deformed into the bearing region 144 of projecting coupling parts 91.

The coupling parts 91 projecting into the bearing region 144 of the oppositely lying coupling element 143 in the engaged position overlap with the coupling parts 91 of the oppositely lying coupling element 143 in at last certain regions, as a result of which the locatable coupling elements 143 are supported against one another and at least lightly clamped in at least certain regions and held positioned in their mutual relative position. The bearing regions 144 thus form an absorption region.

The embodiments illustrated in FIGS. 14 and 15 can naturally also be used with all the other embodiments described in connection with FIGS. 1 to 13, in which case at least two relatively adjustable parts 89, 90 in a motor vehicle can each be provided with a coupling element 143 and these can be adjusted at least at an angle to, in particular perpendicular to the bearing surface in order to produce an engaging and disengaging action. To this end, at least one of the parts 89, 90 is provided with an adjusting device 50; 51; 125, as described in connection with above-mentioned drawings. Naturally, the two parts 89, 90 may be designed so as to be adjustable relative to one another.

When the coupling elements 143 are brought into a released, disengaged open position, the elastically deformed coupling parts 9 are automatically deformed back again. As a result of the clamping action in at least certain regions of the coupling parts of the oppositely lying locatable coupling elements 143, a substantially form-fitting and/or friction locking connection, which may be released as necessary, is produced between the coupling elements 143 and the relatively positioned parts 89, 90. The coupling parts 91 of the coupling element 143 projecting at least slightly towards the bearing surface are disposed on a support body 92 or applied directly to the latter by a co-extrusion process, etc..

FIGS. 16 and 17, which will be described together, show a different embodiment of the locatable coupling elements 143, FIG. 16 illustrating the coupling elements 143 in a disengaged state and FIG. 17 illustrating the coupling elements 143 in an engaged state. The coupling elements 143 are also of a flat design and may be made as a single piece or in several parts or as a single layer or several layers. As illustrated in the drawings, the coupling elements 143 have a flat support body 92, which is directly joined to the part 89, 90 by an adhesive layer 66. The support body 92 is integrally formed and the properties may be the same as or different from the coupling part 91. In the particular embodiment described here, the coupling element 143 is at least one coupling part 91 with a surface profile 151, which may have a regular or irregular recurring ripple 152 pattern. The surface profile 151 is made up of several adjacent, regularly or irregularly spaced profile crests 153 and profile troughs 154, in which a maximum height 155 and a maximum depth 156 are bounded by a base profile 157 and a reference profile 158. Between the base and the reference profiles 157, 158, the profile crests 153 and profile troughs 154 may have a same or shorter height 155 or depth 156. It should be pointed out that the height 155 and depth 156 is measured respectively between a mean profile 159 lying between the base and reference profiles 157, 158. An opening width 161 of a profile trough as measured at the mean profile 159 on a profile surface 160 and between two adjacent coupling parts 91 may be the same as or different from the other opening widths 161 of the other profile troughs 154.

As may also be seen from FIG. 16, the other coupling element 143 which may be releasably located with the first coupling element 143 as necessary is provided with the coupling part 91 incorporating a surface profile 151 made up of several profile crests 153 and profile troughs 154 arranged one after the other. These profile crests 153 and profile troughs 154 may have the same heights 155 and depths 156 as one another and/or as the profile crests 153 and profile troughs 154 of the oppositely lying coupling element 143. A maximum depth 156 of at least one profile trough 154 of the first coupling element 143 may naturally also be smaller than or the same as or bigger than the depth 156 of the profile trough 154 of the other coupling element 143. The same also applies to the maximum height 155 of the profile crests 153 of the first and other coupling element 143.

As may be seen more clearly from FIG. 17, the profile crests 153 and profile troughs 154 of the locatable coupling elements are of an elastically flexible and reversible design so that even if at least two profile crests 153 of the two coupling elements 143 come into contact with one another or abut against one another they are elastically deformed so that as the two profile crests 153 come into contact with one another, material is forced into the profile trough 154 or profile troughs adjacent to the profile crest 153 so that the profile crests 153 are received in essentially corresponding profile troughs 154 in certain regions only. As described above, force is applied—as indicated by arrow 149—to at least one of the parts 89; 90 in order to engage the coupling elements 143 and expediently remains active for the entire duration of the coupled engaged position of the coupling elements 143. As a result of the elastic deformation of the profile crests 153 and/or profile troughs 154 forming the coupling parts and due to the action of the force being applied—as indicated by arrow 149—an increased contact pressure and hence a friction force is obtained between the coupling elements 143 so that the mating or locatable coupling elements 143 are able to transmit force in a direction parallel with the bearing surface 162 of the parts 89, 90. Another major advantage of this embodiment is that in a located engaged position, even if a maximum height 155 of the profile crest 153 is bigger than a minimum depth 156 of a profile trough 154, on the one hand the coupling elements 143 can not be damaged because at least one profile crest 153 and/or at least one profile trough 154 will be elastically deformed whilst on the other hand nevertheless reliably fixing a relative position between two relatively adjustable parts 89, 90. Naturally, it would also be possible for the properties of the two mutually locatable coupling elements 143 to be different.

The locatable coupling elements 143 are disengaged by moving them towards one another in opposite directions against the action of the applied pressure—indicated by arrow 149—so that the elastically flexible and reversible coupling elements 143 and their coupling parts 91 automatically resume their original starting position. As a result, the profile crests 153 and profile troughs 154 of the locatable coupling elements 143 are only partially in an interlocking engaged position. The specific advantage of this is that it achieves a situation in which the profile crests and profile troughs 153, 154 which can be engaged with one another in a form-fitting arrangement can be so to a degree of approximately 30 to 100%, in particular between 50 and 90%, for example 70%, and this will be sufficient to be able to transmit pre-definable forces in the direction parallel with and/or at an angle to the bearing surface 162. The remaining form-fitting and friction-locking interlocking proportion, in other words 70 to 0%, in particular between 50% and 10%, for example 30 %, of the profile crests and profile troughs 153, 154 are elastically deformed in certain regions. It should be pointed out that the proportion, as a percentage, is measured on the basis of the coupling parts 91 and profile crests 153 and profile troughs 154 distributed on the support body surface 146 or the surface 145. For example, it would also be possible for one of the coupling elements 141; 143 to have a different property, for example in terms of its strength, toughness, modulus of elasticity, etc., which will enable a low-force deformation of at least one profile crest 153 of the first coupling element 141 on at least one profile crest 153 of the other coupling element 143. This will also enable different requirements to be accommodated, such as reliably securing the engaged coupling elements 141, 143 to prevent them from coming apart.

In another embodiment, not illustrated, the coupling parts 91 are provided in a filament-type arrangement and when the pressurised coupling elements 65, 72; 141, 143 are brought into engagement with one another they are bent over and/or wrapped and/or enclosed in certain regions. When the substantially cylindrical surfaces of the coupling parts 91 of the coupling elements 65, 72; 141, 143 are brought into direct contact with one another, an increased friction lock is produced between them, which enables high forces to be transmitted in a direction substantially parallel with the bearing surface 53; 54; 71; 123; 129, 137, 140; 162. These filament-type coupling parts 91 are expediently disposed on the flat support body 92, which is joined by the adhesive layer 66 for the form-fitting and/or friction-locking connecting element to the part 89, 90. The coupling parts 91 are separated from one another by a bearing region.

As a result of the embodiments described above and illustrated in FIGS. 1 to 17, higher thrust forces in particular can be transmitted, essentially acting in the direction parallel with the bearing surface 53; 54; 71; 123; 129, 137, 140; 162 without causing the parts 89, 90 to shift. The thrust forces may be approximately between 1% and 30%, for example 5% and 20%, greater than a pressing force needed for the locating action to lock the parts 89, 90.

Finally, it should be pointed out that in order to retain clarity in the drawings, the coupling elements 65, 72, 141, 143 of the coupling mechanism 88 are illustrated in highly simplified and very enlarged diagrams and only a few coupling parts 91 are shown. However, the coupling elements 65, 72 are in fact provided with a plurality of coupling parts 91. Naturally, several coupling mechanisms can be provided one after the other and/or adjacent to one another between the parts 89 and 90, and hence distributed across the bearing surface 53, 54, 71, 123, 129, 162. In particular, the embodiments and applications illustrated in FIGS. 14 to 17 may also be transposed to the embodiments and applications illustrated in FIGS. 1 to 13.

For the sake of good order, finally, it should be pointed out that in order to provide a clearer understanding of the coupling mechanism 88 and the coupling elements 65, 72, 139, 141, 143, they and their constituent parts are illustrated to a certain extent out of proportion and/or very much magnified and/or on a smaller scale. The independent solutions proposed by the invention to the set task may be found in the description.

Above all, the individual embodiments and features of the subject matter illustrated in FIGS. 1, 2; 3, 4, 5, 6; 7, 8, 9; 10, 11, 12; 13; 14, 15; 16, 17 may be construed as independent solutions proposed by the invention. The objectives and associated solutions proposed by the invention may be found in the detailed descriptions of these drawings.

List of reference numbers

1 Steering shaft adjusting unit

2 Steering shaft

3 Adjusting mechanism

4 Fixing system

5 Fixing means

6 Body

7 Mount

8 Profiled piece

9 Support element

10 Base

11 Leg

12 Profile leg

13 Guide mechanism

14 Longitudinal mid-axis

15 Double arrow

16 Double arrow

17 End region

18 End region

19 Bearing

20 Bearing

21 Length

22 Length

23 Length

24 Pivot axis

25 Internal face

26 Guide element

27 Guide track arrangement

28 Length

29 Width

30 Orifice

31 Slot

32 Bore

33 Clamping element

34 Mid-axis

35 Part

36 Part

37 Height

38 Wall thickness

39 Height

40 Wall thickness

41 Base

42 Widthways dimension

43 Connecting region

44 Side leg

45 Side leg

46 Base

47 Transition region

48 Guide track

49 Guide track

50 Adjusting device

51 Adjusting device

52 Operating lever

53 Bearing surface

54 Bearing surface

55 Operating element

56 Plastic plate

57 Sheet metal plate

58 Fixing arrangement

59 Bearing point

60 Bearing point

61 Length

62 Stop element

63 Damping element

64 Adjustment path

65 Coupling element

66 Adhesive layer

67 Base element

68 Longitudinal side region

69 Base surface

70 Longitudinal web

71 Bearing surface

72 Coupling element

73 Guide element

74 Return element

75 Width

76 Longitudinal side face

77 Length

78 Transverse side face

79 Bottom face

80 Longitudinal mid-axis

81 Transverse mid-axis

82 Bore

83 End region

84 Guide and/or stop element

85 Stop surface

86 Coupling element width

87 Coupling element width

88 Coupling mechanism

89 Part

90 Part

91 Coupling part

92 Support body

93 Core

94 Surface

95 Projection

96 Height

97 Height

98 Acceptance angle

99 Distance

100 Arrow

101 Adjustment path

102 Bearing region

103 Double arrow

104 Vehicle seat

105 Seat part

106 Back part

107 Head rest

108 Body part

109 Guide mechanism

110 Reinforcing insert

111 Pivot axis

112 Pivot part

113 Reinforcing element

114 Support element

115 Transverse track

116 Width

117 Adjusting mechanism

118 Guide part

119 Guide part seating

120 Stop element

121 Lateral guide track

122 Height guide track

123 Bearing surface

124 Fixing system

125 Adjusting device

126 Holding part

127 Clamping element

128 Guide bore

129 Bearing surface

130 Guide element

131 End

132 Connecting element

133 Bore

134 Lever

135 Bearing point

136 Handle part

137 Bearing surface

138 Segment

139 Coupling element

140 Bearing surface

141 Coupling element

142 Cavity

143 Coupling element

144 Bearing region

145 Surface

146 Support body surface

147 Support surface

148a Separating distance

148b Separating distance

149 Arrow

150 Flank angle

151 Surface profile

152 Ripple pattern

153 Profile crest

154 Profile trough

155 Height

156 Depth

157 Base profile

158 Reference profile

159 Mean profile

260 Profiled surface

261 Opening width

262 Bearing surface

1. Coupling mechanism, in particular for at least two relatively adjustable parts, each of which is provided with at least one coupling element and the coupling elements are provided with coupling parts which are oriented at least at an angle to a bearing surface of the parts receiving them and can be brought into engagement with one another, being distributed on a surface and having upstanding, slightly elastically flexible projections, characterised in that the parts (89; 90) can be pressurised in order to transmit force in the direction parallel with the bearing surface (53; 54; 71; 123; 129, 137, 140; 162) and are disposed so as to be relatively adjustable by means of an adjusting device (50; 51; 125) for engaging or disengaging the locatable coupling elements (65, 72, 139, 141; 143) at least at an angle relative to the bearing surface (53; 54; 71; 123; 129, 137, 140), in particular perpendicular to the bearing surface (53; 54; 71; 123; 129, 137, 140; 162).

2. Coupling mechanism, in particular for at least two relatively adjustable parts, each of which is provided with at least one coupling element and the coupling elements are provided with coupling parts standing at least slightly proud of a bearing surface of the parts receiving them and can be brought into engagement with one another, characterised in that the coupling parts (91) are elastically flexible and reversible and are designed to be locatable with one another in certain regions in each of their relative positions in order to releasably fix the positioned parts (89, 90).

3. Coupling mechanism as claimed in claim 1 or 2, characterised in that at least one of the locatable coupling elements (65, 72) is pressurised into a located, fixing locking position by means of a pressure force.

4. Coupling mechanism as claimed in one or more of the preceding claims characterised in that the adjusting device (50; 51; 125) is designed to apply the pressure force to at least one of the coupling elements (65; 72; 143).

5. Coupling mechanism as claimed in one or more of the preceding claims, characterised in that the force which can be transmitted in the direction parallel with the bearing surface (53; 54; 71; 123; 129, 137, 140; 162) is specifically between 1% and 30%, for example 5% and 20%, greater than a pressure force needed for locating purposes.

6. Coupling mechanism as claimed in one or more of claims 2 to 5, characterised in that the coupling part (91) is provided in the form of a surface profile (151) with profile crests (153) and profile troughs (154) distributed regularly or irregularly along a surface (145) or support body surface (146).

7. Coupling mechanism as claimed in one or more of claims 2 to 6, characterised in that the surface profile (151) is provided in the form of a regular or irregular recurring ripple pattern (152).

8. Coupling mechanism as claimed in one or more of claims 2 to 7, characterised in that the coupling elements (143), which can be located with one another in at least certain regions, have an identical surface profile (151) by reference to a pre-definable surface.

9. Coupling mechanism as claimed in one or more of claims 2 to 7, characterised in that the coupling elements (143) which can be located with one another in at least certain regions have a different surface profile (151) by reference to a pre-definable surface.

10. Coupling mechanism as claimed in one or more of claims 2 to 9, characterised in that an opening width (161) of the profile troughs (154) extending parallel with the surface (145) measured with respect to a mean profile (159) based on the profile crests (153) and profile troughs (154) differs.

11. Coupling mechanism as claimed in one or more of claims 2 to 10, characterised in that the coupling parts (91) and the profile crests (153) and/or profile troughs (154) forming them are designed to be elastically and reversibly deformable, preferably in three directions.

12. Coupling mechanism as claimed in one or more of claims 2 to 11, characterised in that when the parts (89, 90) come into direct contact or abutment, at least two profile crests (153) of the coupling elements (143) are caused to bend in the profiled surface (160) of at least one coupling element (143) and the coupling elements (143) are fixed to one another in a form-fitting and friction-locking arrangement.

13. Coupling mechanism as claimed in one or more of claims 2 to 12, characterised in that that it is made of a single part or multiple parts and of a single layer or multiple layers.

14. Coupling mechanism as claimed in one or more of claims 2 to 13, characterised in that one of the coupling elements (141, 143) has a property that is different from the other coupling element (141, 143), for example in terms of strength, toughness, modulus of elasticity, etc..

15. Coupling mechanism as claimed in one of claims 2 to 14, characterised in that the coupling element (141, 143) has a property in the region of the profiled surface (160) that is different from the rest of the coupling part (91), for example in terms of strength, toughness, modulus of elasticity, etc..

16. Coupling mechanism as claimed in one or more of claims 2 to 15, characterised in that it is provided with an elastically deformable reversible layer and/or with at least one projection (95) standing proud of the layer in the region of the profiled surface (160).

17. Coupling mechanism as claimed in one or more of claims 2 to 16, characterised in that a number of the coupling parts (91) and/or dividing spaces (148a, 148b) between two adjacent coupling parts (91) of the coupling elements which can be brought into engagement with one another is and/or are different.

18. Coupling mechanism as claimed in one or more of claims 2 to 17, characterised in that the mutually locatable coupling elements (143) have at least one bearing region (144) disposed between two mutually adjacent coupling parts (91) as a bearing for several coupling parts (91) which project into them.

19. Coupling mechanism as claimed in one or more of claims 2 to 18, characterised in that the part-regions or a proportion of the coupling parts (91) of the mutually engaged coupling elements (143) are located with one another in a form-fitting arrangement and the other proportion of the coupling parts (91) are located with one another in a friction-locking arrangement.

20. Coupling mechanism as claimed in one or more of claims 2 to 19, characterised in that the force-transmitting proportion of the coupling parts (91) which can be brought into engagement with one another in a form-fitting arrangement constitute between 30% and 100%, in particular between 50% and 90%.

21. Coupling mechanism as claimed in one or more of claims 2 to 20, characterised in that the force-transmitting proportion of the coupling parts (91) which can be brought into engagement with one another in a friction-locking arrangement constitute between 70% and 0%, in particular between 50% and 10%.

22. Coupling mechanism as claimed in one or more of claims 2 to 21, characterised in that a separating distance (148a, 148b) measured between two mutually adjacent coupling parts (91) of the mutually locatable coupling elements (143) is identical.

23. Coupling mechanism as claimed in one or more of claims 2 to 22, characterised in that the coupling part (91) has at least one, in particular several, slightly elastically flexible projections distributed across and standing proud of its surface or has a slightly elastically flexible coating.

24. Coupling mechanism as claimed in one or more of claims 2 to 23, characterised in that when the coupling elements (141; 143) are in a located locking position, a pressing force—as indicated by arrow (149)—applied to at least one of the parts (89; 90) of the adjusting device (50; 51; 125) is at least slightly greater than the reaction force induced by the elastically deformed coupling parts (91).

25. Coupling mechanism as claimed in one or more of the preceding claims, characterised in that the coupling elements (65, 72, 143) interlock with one another in a form-fitting arrangement when in a located, fixed locking position and the pressure force applied by the adjusting device (50; 51; 125) releasably fixes the parts (89, 90) in their relative position against the action of at least one elastic return element (74).

26. Coupling mechanism as claimed in one or more of the preceding claims, characterised in that the coupling elements (65, 72) can be located with one another in each of their relative positions.

27. Coupling mechanism as claimed in one or more of the preceding claims, characterised in that the coupling elements (65; 72) have a flat support body (92) which is provided with coupling parts (91) distributed across the surface.

28. Coupling mechanism as claimed in one or more of the preceding claims, characterised in that in the located, fixed locking position, the mutually facing coupling elements (65; 72) are located with one another in a locking arrangement and the parts (89; 90) are releasably fixed and held mutually positioned with essentially no clearance by means of the mutually locatable coupling elements (65, 72) in the direction parallel with the bearing surface (53; 54; 71; 123; 129).

29. Coupling mechanism as claimed in one or more of the preceding claims, characterised in that a distance (99) between the mutually abutting parts (89; 90) in a located, fixed locking position of the coupling elements (65, 72) is at least slightly greater than a maximum height (96, 97) of the coupling parts (91).

30. Coupling mechanism as claimed in one or more of the preceding claims, characterised in that the part or parts (89; 90) is or are made from plastic and the coupling elements (65; 72) are extruded on.

31. Coupling mechanism as claimed in one or more of the preceding claims, characterised in that the part or parts (89; 90) and the coupling elements (65; 72), in particular the coupling parts (91), are made from a metal material and the coupling parts (91) have slightly elastically flexible, metal projections (95).

32. Coupling mechanism as claimed in one or more of the preceding claims, characterised in that the coupling parts (91), in particular the cores (93), are of an at least slightly elastically flexible design and have a cross section that is substantially frustoconical, pyramid-shaped, cylindrical, etc., or are designed in a filament-like arrangement.

33. Coupling mechanism as claimed in one or more of the preceding claims, characterised in that the coupling element (65; 72) is of an integral design and is made from a uniform material.

34. Coupling mechanism as claimed in one or more of the preceding claims, characterised in that the coupling element (65; 72) is made from materials having different properties, in particular strength and/or toughness properties.

35. Coupling mechanism as claimed in one or more of the preceding claims, characterised in that at least one strip-shaped coupling element (65) is joined to the first part (89), in particular the support element (9), and at least another strip-shaped coupling element (72) is joined to the other part (90), in particular a base element (67), in a form-fitting and/or friction-locking arrangement.

36. Coupling mechanism as claimed in one or more of the preceding claims, characterised in that the first part (89), in particular the support element (9), has a slot (31) extending in the longitudinal direction of the steering shaft (2) and at least one, in particular several, strip-shaped coupling elements (65) are disposed on an internally lying bearing surface (54) in a region bounding the slot (31) in the longitudinal extension of the slot (31).

37. Coupling mechanism as claimed in one or more of the preceding claims, characterised in that the first part (89), in particular the mount (7), has at least one orifice (30) extending transversely to the longitudinal direction of the steering shaft (2) and at least one, in particular several, strip-shaped coupling elements (65) extending parallel with the orifice (30) and parallel with each other are disposed on an outwardly lying bearing surface (53) of the mount (7) in a region bounding the orifice (30) in the longitudinal extension of the orifice (30), which is curved and in particular convexly slot-shaped facing a pivot axis (24).

38. Coupling mechanism as claimed in one or more of the preceding claims, characterised in that at least one adjusting mechanism (50; 51) is disposed between the steering shaft (2) and a support element (9) and/or another is disposed between the mount (7) and an operating lever (52) and the adjusting device or devices (50; 51) and the operating lever (52) are retained concentrically and in alignment with one another by a clamping element (33).

39. Coupling mechanism as claimed in one or more of the preceding claims, characterised in that the adjusting mechanism (50, 51) consists of a strip-shaped base element (67), at least one strip-shaped guide element (73) and at least one elastic return element (74) disposed between the guide element (73) and the base element (67).

40. Coupling mechanism as claimed in one or more of the preceding claims, characterised in that in a disengaged, released open position, the pressurised guide elements (73) of the adjusting devices (50; 51) are guided by means of the return elements (74), substantially without any clearance, on the bearing surfaces (53; 54) of the mount (7) and/or the support element (9) directed towards the latter and the mutually locatable coupling elements (65; 72) are disposed at a distance apart from one another.

41. Coupling mechanism as claimed in one or more of the preceding claims, characterised in that in the located, fixed, locking position, the oppositely lying mutually facing coupling elements (65; 72) are engaged and the at least one, in particular several, coupling parts (91) incorporating radial, peripherally extending projections (95) are supported against one another.

42. Coupling mechanism as claimed in one or more of the preceding claims, characterised in that at least one coupling part (91) of the one coupling element (72) locates in a bearing region (102) of the other coupling element (65) between spaced apart coupling parts (91) and at least part-regions of the surface (94) or projections (95) of the coupling parts (91) are pressed against one another with a pre-settable contact force.

43. Coupling mechanism as claimed in one or more of the preceding claims, characterised in that at least one strip-shaped coupling element (65) of the coupling mechanism (88) is joined to the first part (89), in particular a guide part (118), and another strip-shaped coupling element (72) is joined to the other part (90), in particular a support part, of the adjusting device (125) in a form-fitting and/or friction locking arrangement.

44. Coupling mechanism as claimed in one or more of the preceding claims, characterised in that the coupling element (65; 72) is bonded, welded, riveted, etc., onto the bearing surface (53; 54; 71; 123; 129).

45. Coupling mechanism as claimed in one or more of the preceding claims, characterised in that the coupling elements (65, 72) are disposed between a support element (114) and a back part (106) of a vehicle seat (104) or seat for releasably fixing a variably set inclination between the back part (106) and the seat part (105).

46. Coupling mechanism as claimed in one or more of the preceding claims, characterised in that the coupling elements (65, 72) are disposed between a body part of a vehicle forming the first part (89) and the other part (90) of a height adjusting mechanism of a strap-type restraining element, in particular a belt, for releasably fixing a variably set height or length thereof.

47. Coupling mechanism as claimed in one or more of the preceding claims, characterised in that the first part (89) and the other part (90) are disposed one inside the other and the fist inner part (89) is provided with at least one coupling element (139) on its outer periphery forming a bearing surface (137) and the other outer part (90) has at least one other coupling element (141) on its inner periphery forming a bearing surface (14) directed towards the outer periphery of the first part (89).

48. Coupling mechanism as claimed in one or more of the preceding claims, characterised in that at least part-regions of one of the tubular parts (89, 90), in particular the inner part (89), is designed so as to be elastically deformable in the radial direction relative to the bearing surface (129; 140) and is line-connected to an adjusting mechanism, in particular an actuator, via a connecting line in order to apply pressure to a cavity (142).

49. Coupling mechanism as claimed in one or more of the preceding claims, characterised in that the adjusting devices (50; 51; 125) of fixing systems (4; 124), in particular the coupling mechanism (88), can be operated by electrical, mechanical, pneumatic, hydraulic actuators.

50. Coupling mechanism as claimed in one or more of the preceding claims, characterised in that the actuators are provided in the form of slide tracks, positioning elements, roller elements, etc., which are actively linked to the coupling elements (65; 72) during operation.

51. Use of the coupling elements as an energy-absorbing deformation system for a force and energy acting in the longitudinal direction and/or transversely to the longitudinal direction of the steering shaft.
